(19) United States
(12) Patent Application Publication
(10) Pub. No.: US 2025/0385633 A1
(43) Pub. Date: Dec. 18, 2025

(54) MOTOR CONTROL DEVICE

(71) Applicant: NIDEC CORPORATION, Kyoto (JP)

(72) Inventors: Kotaro KATAOKA, Kyoto (JP); Tomohiro FUKUMURA, Kyoto (JP)

(21) Appl. No.: 18/693,950

(22) PCT Filed: Jun. 16, 2022
(86) PCT No.: PCT/JP2022/024198

§ 371 Date: Feb. 6, 2025

(30) Foreign Application Priority Data
Sep. 30, 2021 (JP) 2021-162378

(51) Int. Cl. H02P 29/50; H02P 27/08

(52) U.S. Cl. CPC H02P 29/50; H02P 27/085

(57) ABSTRACT

A controller controls a conversion circuit of an n-phase motor based on updated n-phase duty command values. When the controller predicts that voltage fluctuations of first-phase and second-phase terminals connected to the motor occur in the same direction and at the same timing based on a current update value of the n-phase duty command value, it shifts the occurrence timing of the voltage fluctuation of the first-phase terminal determined by the current update value in a first direction by a first time, shifts the occurrence timing of the voltage fluctuation of the remaining terminal determined by the current update value in the first direction by a third time, and shifts the occurrence timing of the voltage fluctuation of the second-phase terminal determined by the next update value or the previous update value of the n-phase duty command value in a direction opposite to the first direction by a second time.

### CROSS-REFERENCE TO RELATED APPLICATIONS

This is the U.S. national stage of application No. PCT/JP2022/024198, filed on Jun. 16, 2022, and priority under 35 U.S.C. § 119(a) and 35 U.S.C. § 365(b) is claimed from Japanese Patent Application No. 2021-162378, filed on Sep. 30, 2021.

### FIELD OF THE INVENTION

The present invention relates to a motor control device.

### BACKGROUND

Conventionally, a technique of generating three-phase pulse width modulation (PWM) signals using three types of basic voltage vectors in an inverter device that supplies a three-phase AC voltage to a three-phase motor, and generating a switching signal to be supplied to each of at least six switching elements included in the inverter device on the basis of the three-phase PWM signals is known.

For example, at the moment when the switching timings of the two-phase PWM signals among the three-phase PWM signals match, a potential difference (shaft voltage) between the output shaft of the motor and the motor case may greatly fluctuate instantaneously. This may cause noise.

In another respect, electrolytic corrosion may occur in the rotor bearing of the motor due to the shaft voltage. As a result of studies by the inventors of the present application, it has been found that particularly this noise may affect the occurrence of electrolytic corrosion.

### SUMMARY

One aspect of an exemplary motor control device of the present invention is a motor control device that controls an n-phase motor (n is an integer of 3 or more). The exemplary motor control device includes a power conversion circuit that is connected to the n-phase motor and performs mutual conversion between DC power and n-phase AC power, and a control unit that controls the power conversion circuit on the basis of n-phase duty command values updated at a predetermined update cycle. When the control unit predicts, based on current update values of the n-phase duty command values, that voltage fluctuations of connection terminals of at least a first phase and a second phase among n-phase connection terminals connected to the n-phase motor occur in the same direction and at the same timing, the control unit shifts the occurrence timing of the voltage fluctuation of the connection terminal of the first phase determined by the current update value in a first direction by a first time, shifts the occurrence timing of the voltage fluctuation of the remaining connection terminal determined by the current update value in the first direction by a third time, and shifts the occurrence timing of the voltage fluctuation of the connection terminal of the second phase determined by a next update value or a previous update value of the n-phase duty command value in a direction opposite to the first direction by a second time.

The above and other elements, features, steps, characteristics and advantages of the present disclosure will become more apparent from the following detailed description of the preferred embodiments with reference to the attached drawings.

### BRIEF DESCRIPTION OF THE DRAWINGS

FIG. 1 is a circuit block diagram schematically illustrating the configuration of a motor control device according to a first embodiment of the present invention;

FIG. 2 is a diagram schematically illustrating the principle of generating three-phase PWM signals based on three-phase duty command values;

FIG. 3 is a timing chart illustrating an example in which a falling edge timing of a V-phase PWM signal matches a falling edge timing of a W-phase PWM signal;

FIG. 4 is a timing chart illustrating the basic concept of the present invention;

FIG. 5 is a timing chart illustrating an example in which a rising edge timing of a V-phase PWM signal matches a rising edge timing of a W-phase PWM signal in a state where the duty ratios of the V-phase PWM signal and the W-phase PWM signal are close to 100%;

FIG. 6 is a timing chart illustrating an example of three-phase PWM signals generated by a comparison technique when a rising edge timing of a V-phase PWM signal matches a rising edge timing of a W-phase PWM signal in a state where the duty ratios of the V-phase PWM signal and the W-phase PWM signal are close to 100%;

FIG. 7 is a timing chart illustrating an example of three-phase PWM signals generated by the present embodiment when a rising edge timing of a V-phase PWM signal matches a rising edge timing of a W-phase PWM signal in a state where the duty ratios of the V-phase PWM signal and the W-phase PWM signal are close to 100%;

FIG. 8 is a timing chart illustrating an example of three-phase PWM signals generated by the present embodiment when a falling edge timing of a V-phase PWM signal matches a falling edge timing of a W-phase PWM signal in a state where the duty ratios of the V-phase PWM signal and the W-phase PWM signal are close to 100%;

FIG. 9 is a timing chart illustrating an example in which a rising edge timing of a U-phase PWM signal matches a rising edge timing of a V-phase PWM signal in a state where the duty ratios of the U-phase PWM signal and the V-phase PWM signal are close to 0%;

FIG. 10 is a timing chart illustrating an example of three-phase PWM signals generated by a comparison technique when a rising edge timing of a U-phase PWM signal matches a rising edge timing of a V-phase PWM signal in a state where the duty ratios of the U-phase PWM signal and the V-phase PWM signal are close to 0%;

FIG. 11 is a timing chart illustrating an example of three-phase PWM signals generated by the present embodiment when a rising edge timing of a U-phase PWM signal matches a rising edge timing of a V-phase PWM signal in a state where the duty ratios of the U-phase PWM signal and the V-phase PWM signal are close to 0%;

FIG. 12 is a timing chart illustrating an example of three-phase PWM signals generated by the present embodiment when a falling edge timing of a U-phase PWM signal matches a falling edge timing of a V-phase PWM signal in a state where the duty ratios of the U-phase PWM signal and the V-phase PWM signal are close to 0%;

FIG. 13 is a timing chart illustrating an example of three-phase PWM signals generated by the normal center alignment mode when a rising edge timing of a V-phase PWM signal matches a rising edge timing of a W-phase PWM signal in a state where the duty ratios of the V-phase PWM signal and the W-phase PWM signal are close to 100%;

FIG. 14 is a timing chart illustrating an example of three-phase PWM signals generated by the normal center alignment mode when a rising edge timing of a U-phase PWM signal matches a rising edge timing of a V-phase PWM signal in a state where the duty ratios of the U-phase PWM signal and the V-phase PWM signal are close to 0%;

FIG. 15 is a timing chart illustrating an example in which a rising edge timing of a V-phase PWM signal matches a rising edge timing of a W-phase PWM signal in a state where the duty ratio of the U-phase PWM signal is close to 0% and the duty ratios of the V-phase PWM signal and the W-phase PWM signal are close to 100%;

FIG. 16 is a timing chart illustrating an example of three-phase PWM signals generated by the present embodiment when a rising edge timing of a V-phase PWM signal matches a rising edge timing of a W-phase PWM signal in a state where the duty ratio of the U-phase PWM signal is close to 0% and the duty ratios of the V-phase PWM signal and the W-phase PWM signal are close to 100%;

FIG. 17 is a timing chart illustrating an example in which a falling edge timing of a V-phase PWM signal matches a falling edge timing of a W-phase signal in a state where the duty ratio of the U-phase PWM signal is close to 0% and the duty ratios of the V-phase PWM signal and the W-phase PWM signal are close to 100%;

FIG. 18 is a timing chart illustrating an example of three-phase PWM signals generated by the present embodiment when a falling edge timing of a V-phase PWM signal matches a falling edge timing of a W-phase PWM signal in a state where the duty ratio of the U-phase PWM signal is close to 0% and the duty ratios of the V-phase PWM signal and the W-phase PWM signal are close to 100%;

FIG. 19 is a timing chart illustrating an example in which a rising edge timing of a V-phase signal matches a rising edge timing of a W-phase signal in a state where the duty ratio of the U-phase PWM signal is close to 100% and the duty ratios of the V-phase PWM signal and the W-phase PWM signal are close to 0%;

FIG. 20 is a timing chart illustrating an example of three-phase PWM signals generated by the present embodiment when a rising edge timing of a V-phase PWM signal matches a rising edge timing of a W-phase PWM signal in a state where the duty ratio of the U-phase PWM signal is close to 100% and the duty ratios of the V-phase PWM signal and the W-phase PWM signal are close to 0%;

FIG. 21 is a timing chart illustrating an example in which a falling edge timing of a V-phase PWM signal matches a falling edge timing of a W-phase signal in a state where the duty ratio of the U-phase PWM signal is close to 100% and the duty ratios of the V-phase PWM signal and the W-phase PWM signal are close to 0%;

FIG. 22 is a timing chart illustrating an example of three-phase PWM signals generated by the present embodiment when a falling edge timing of a V-phase PWM signal matches a falling edge timing of a W-phase PWM signal in a state where the duty ratio of the U-phase PWM signal is close to 100% and the duty ratios of the V-phase PWM signal and the W-phase PWM signal are close to 0%;

FIG. 23 is a timing chart illustrating an example of waveforms of a U-phase upper gate control signal G1, a U-phase lower gate control signal G2, a U-phase terminal voltage Vu, a V-phase upper gate control signal G3, a V-phase lower gate control signal G4, a V-phase terminal voltage Vv, a W-phase upper gate control signal G5, a W-phase lower gate control signal G6, and a W-phase terminal voltage Vw, in the case where both directions of the V-phase and W-phase currents are directions from a power conversion circuit toward a three-phase motor; and

FIG. 24 is a timing chart illustrating an example of waveforms of a U-phase upper gate control signal G1, a U-phase lower gate control signal G2, a U-phase terminal voltage Vu, a V-phase upper gate control signal G3, a V-phase lower gate control signal G4, a V-phase terminal voltage Vv, a W-phase upper gate control signal G5, a W-phase lower gate control signal G6, and a W-phase terminal voltage Vw, in the case where the direction of the W-phase current is a direction from a power conversion circuit toward a three-phase motor and the direction of the V-phase current is a direction from the three-phase motor toward the power conversion circuit.

### DETAILED DESCRIPTION

An embodiment of the present invention will be described in detail below with reference to the drawings.

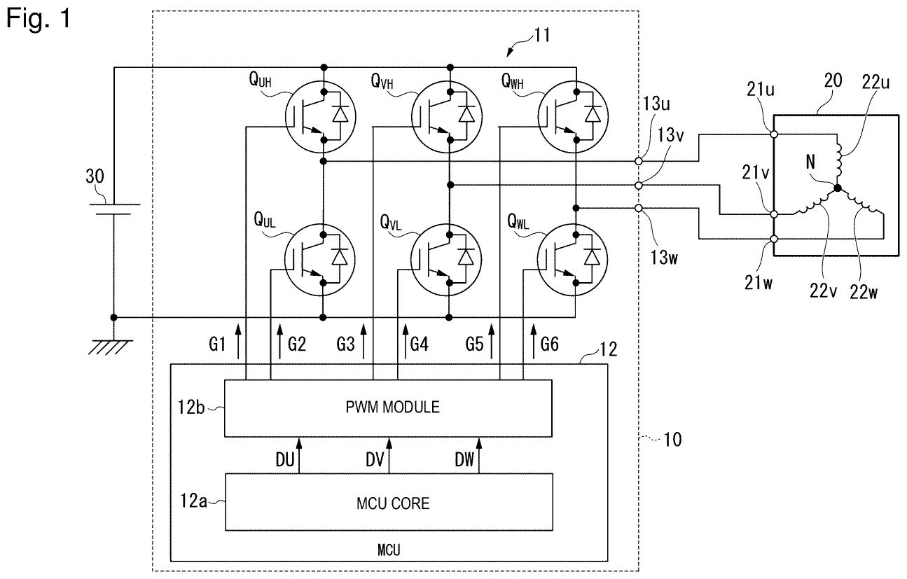

FIG. 1 is a circuit block diagram schematically illustrating the configuration of a motor control device 10 according to the present embodiment. As illustrated in FIG. 1, the motor control device 10 controls a three-phase motor 20. For example, the three-phase motor 20 is an inner rotor type three-phase brushless DC motor. The three-phase motor 20 is, for example, a driving motor (traction motor) mounted on an electric vehicle.

The three-phase motor 20 includes a U-phase terminal 21u, a V-phase terminal 21v, a W-phase terminal 21w, a U-phase coil 22u, a V-phase coil 22v, and a W-phase coil 22w. Although not illustrated in FIG. 1, the three-phase motor 20 includes a motor case, and a rotor and a stator housed in the motor case. The rotor is a rotating body rotatably supported by a bearing component such as a rotor bearing inside the motor case. The rotor has an output shaft coaxially joined to the rotor in a state of axially penetrating the radially inner side of the rotor. The stator is fixed inside the motor case in a state of surrounding an outer peripheral surface of the rotor, and generates an electromagnetic force necessary for rotating the rotor.

The U-phase terminal 21u, the V-phase terminal 21v, and the W-phase terminal 21w are metal terminals each exposed from a surface of the motor case. The U-phase terminal 21u is connected to a U-phase connection terminal 13u of the motor control device 10. The V-phase terminal 21v is connected to a V-phase connection terminal 13v of the motor control device 10. The W-phase terminal 21w is connected to a W-phase connection terminal 13w of the motor control device 10. The U-phase coil 22u, the V-phase coil 22v, and the W-phase coil 22w are excitation coils provided in the stator. As an example, the U-phase coil 22u, the V-phase coil 22v, and the W-phase coil 22w are star-connected inside the three-phase motor 20.

The U-phase coil 22u is connected between the U-phase terminal 21u and a neutral point N. The V-phase coil 22v is connected between the V-phase terminal 21v and the neutral point N. The W-phase coil 22w is electrically connected between the W-phase terminal 21w and the neutral point N. When the energization states of the U-phase coil 22u, the V-phase coil 22v, and the W-phase coil 22w are controlled by the motor control device 10, an electromagnetic force necessary for rotating the rotor is generated. When the rotor rotates, the output shaft also rotates in synchronization with the rotor.

The motor control device 10 includes a power conversion circuit 11 and a microcontroller unit (MCU) 12. The power conversion circuit 11 is connected to the three-phase motor 20 and performs mutual conversion between the DC power and the three-phase AC power. When the power conversion circuit 11 functions as an inverter, the power conversion circuit 11 converts the DC power supplied from the DC power supply 30 into three-phase AC power and outputs the three-phase AC power to the three-phase motor 20. As an example, the DC power supply 30 is one of a plurality of batteries mounted on an electric vehicle.

The power conversion circuit 11 includes a U-phase upper arm switch Q_{UH}, a V-phase upper arm switch Q_{VH}, a W-phase upper arm switch Q_{WH}, a U-phase lower arm switch Q_{UL}, a V-phase lower arm switch Q_{VL}, and a W-phase lower arm switch Q_{WL}. In the present embodiment, each arm switch is, for example, an insulated gate bipolar transistor (IGBT).

The collector terminal of the U-phase upper arm switch Q_{UH}, the collector terminal of the V-phase upper arm switch Q_{VH}, and the collector terminal of the W-phase upper arm switch Q_{WH} each are connected to the positive electrode terminal of the DC power supply 30. The emitter terminal of the U-phase lower arm switch Q_{UL}, the emitter terminal of the V-phase lower arm switch Q_{VL}, and the emitter terminal of the W-phase lower arm switch Q_{WL} each are connected to the negative electrode terminal of the DC power supply 30.

The emitter terminal of the U-phase upper arm switch Q_{UH} is connected to each of the U-phase connection terminal 13u and the collector terminal of the U-phase lower arm switch Q_{UL}. That is, the emitter terminal of the U-phase upper arm switch QUE is connected to the U-phase terminal 21u of the three-phase motor 20 via the U-phase connection terminal 13u. The emitter terminal of the V-phase upper arm switch Q_{VH} is connected to each of the V-phase connection terminal 13v and the collector terminal of the V-phase lower arm switch Q_{VH}. That is, the emitter terminal of the V-phase upper arm switch Q_{VH} is connected to the V-phase terminal 21v of the three-phase motor 20 via the V-phase connection terminal 13v. The emitter terminal of the W-phase upper arm switch Q_{WH} is connected to each of the W-phase connection terminal 13w and the collector terminal of the W-phase lower arm switch Q_{WL}. That is, the emitter terminal of the W-phase upper arm switch Q_{WH} is connected to the W-phase terminal 21w of the three-phase motor 20 via the W-phase connection terminal 13w.

The gate terminal of the U-phase upper arm switch Q_{UH}, the gate terminal of the V-phase upper arm switch Q_{VH}, and the gate terminal of the W-phase upper arm switch Q_{WH} each are connected to the output terminal of the MCU 12. Further, the gate terminal of the U-phase lower arm switch Q_{UL}, the gate terminal of the V-phase lower arm switch Q_{VH}, and the gate terminal of the W-phase lower arm switch Q_{WL} each are also connected to the output terminal of the MCU 12.

As described above, the power conversion circuit 11 is configured of a three-phase full-bridge circuit having three upper arm switches and three lower arm switches. The power conversion circuit 11 configured as described above performs mutual conversion between the DC power and the three-phase AC power by performing switching control of each arm switch by the MCU 12.

The MCU 12 is a control unit that controls the power conversion circuit 11 on the basis of three-phase duty command values updated at a predetermined update cycle. The three-phase duty command values include a U-phase duty command value DU, a V-phase duty command value DV, and a W-phase duty command value DW. The MCU 12 includes an MCU core 12a and a PWM module 12b.

The MCU core 12a executes a command value calculation process of calculating at least three-phase duty command values according to a program stored in advance in a memory (not illustrated). Although not illustrated in FIG. 1, a torque command value output from the host control device is input to the MCU 12. For example, the host control device is an electronic control unit (ECU) mounted on an electric vehicle. For example, the MCU core 12a calculates a q-axis current command value and a d-axis current command value based on the torque command value, and calculates three-phase duty command values as three-phase voltage command values on the basis of these current command values. Torque control of the three-phase motor 20 is a known technique, and thus detailed description thereof is omitted in the present specification.

The MCU core 12a outputs the calculated three-phase duty command values, that is, a U-phase duty command value DU, a V-phase duty command value DV, and a W-phase duty command value DW, to the PWM module 12b. The PWM module 12b generates a gate control signal to be supplied to the gate terminal of each arm switch included in the power conversion circuit 11, on the basis of the U-phase duty command value DU, the V-phase duty command value DV, and the W-phase duty command value DW.

The gate control signal includes a U-phase upper gate control signal G1 supplied to the gate terminal of the U-phase upper arm switch Q_{UH} and a U-phase lower gate control signal G2 supplied to the gate terminal of the U-phase lower arm switch Q_{UL}. The gate control signal also includes a V-phase upper gate control signal G3 supplied to the gate terminal of the V-phase upper arm switch Q_{VH} and a V-phase lower gate control signal G4 supplied to the gate terminal of the V-phase lower arm switch Q_{VL}. In addition, the gate control signal includes a W-phase upper gate control signal G5 supplied to the gate terminal of the W-phase upper arm switch Q_{WH} and a W-phase lower gate control signal G6 supplied to the gate terminal of the W-phase lower arm switch Q_{WL}. A dead time is inserted to each gate control signal in order to prevent the upper arm switch and the lower arm switch of the same phase from being simultaneously switched on.

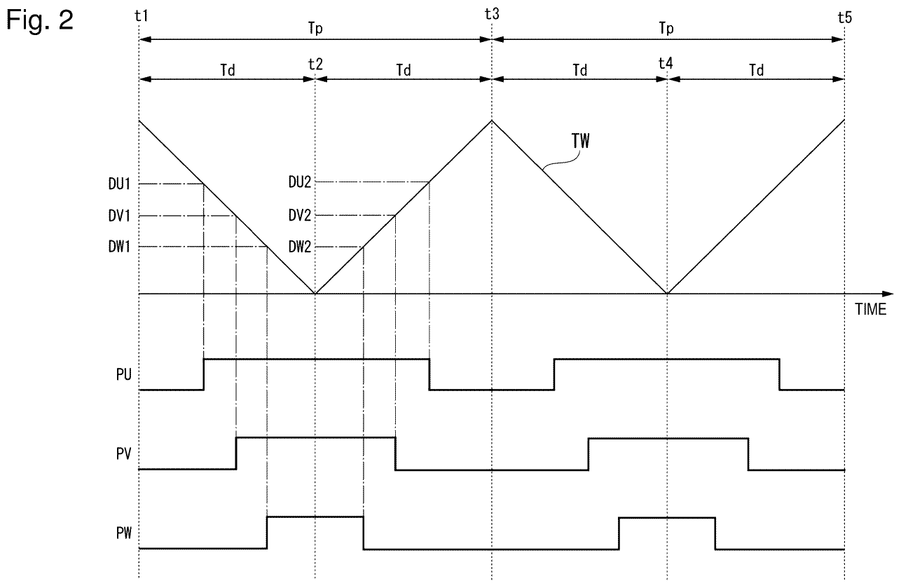

FIG. 2 is a diagram schematically illustrating the principle of generating three-phase PWM signals based on the three-phase duty command values. As illustrated in FIG. 2, the PWM module 12b generates a triangular wave TW having a predetermined cycle Tp. Hereinafter, the cycle Ip of the triangular wave TW may be referred to as a PWM cycle.

As an example, the triangular wave TW includes a count value of a PWM timer. In the example illustrated in FIG. 2, the count value of the PWM timer changes from the maximum value to the minimum value by the PWM timer operating in the countdown mode in the period from time t1 to time t2. Furthermore, in the period from time t2 to time t3, the count value of the PWM timer changes from the minimum value to the maximum value by the PWM timer operating in the count-up mode. A period from time t1 to time t3 corresponds to a cycle of the triangular wave TW, that is, PWM cycle Tp.

Each of the countdown period from time t1 to time t2 and the count-up period from time t2 to time t3 corresponds to a period of ½ of the PWM cycle Tp. The three-phase duty command values are updated at each of the countdown start time t1 and the count-up start time t2. That is, the update cycle Td of the three-phase duty command values corresponds to a period of ½ of the PWM cycle Tp.

In the PWM module 12b, a buffer register and an update register are allocated to each of the three duty command values included in the three-phase duty command values. The three-phase duty command value calculated by the MCU core 12a is first stored in the buffer register. Then, when the update timing such as the countdown start time t1 or the count-up start time t2 arrives, the three-phase duty command value stored in each buffer register is transferred to the update register. As described above, “the three-phase duty command value is updated” means that the three-phase duty command value is transferred from the buffer register to the update register at the update timing.

As described above, since the three-phase duty command value calculated by the MCU core 12a needs to be stored in the buffer register before the update timing arrives, the MCU core 12a calculates the three-phase duty command value at a timing earlier than the update timing. That is, the MCU core 12a calculates the three-phase duty command value to be updated at the countdown start time t1 at a timing earlier than the countdown start time t1, and outputs the calculated value to the PWM module 12b. In addition, the MCU core 12a calculates the three-phase duty command value to be updated at the count-up start time t2 at a timing earlier than the count-up start time t2, and outputs the calculated value to the PWM module 12b. In this manner, the MCU core 12a repeats the command value calculation process at the same cycle as the update cycle Td of the three-phase duty command value, but the command value calculation timing is earlier than the update timing.

As illustrated in FIG. 2, it is assumed that the U-phase duty command value DU is updated to “DU1”, the V-phase duty command value DV is updated to “DV1”, and the W-phase duty command value DW is updated to “DW1” at the countdown start time t1. The U-phase duty command value DU1 is larger than the V-phase duty command value DV1. The V-phase duty command value DV1 is larger than the W-phase duty command value DW1. “DU1”, “DV1”, and “DW1” are values in the update registers allocated to the duty command values respectively as described above.

When the triangular wave TW reaches the three-phase duty command values while the triangular wave TW is descending, the three-phase PWM signals each go to a high level. In other words, during the countdown operation of the PWM timer, the three-phase PWM signals each go to a high level at a timing when the count value of the PWM timer matches the three-phase duty command values.

Therefore, as illustrated in FIG. 2, in the countdown period from time t1 to time t2, the U-phase PWM signal PU goes to a high level at a timing when the count value of the PWM timer matches the U-phase duty command value DU1. In the countdown period from time t1 to time t2, the V-phase PWM signal PV goes to a high level at a timing when the count value of the PWM timer matches the V-phase duty command value DV1. In the countdown period from time t1 to time t2, the W-phase PWM signal PW goes to a high level at a timing when the count value of the PWM timer matches the W-phase duty command value DW1.

As illustrated in FIG. 2, it is assumed that the U-phase duty command value DU is updated to “DU2”, the V-phase duty command value DV is updated to “DV2”, and the W-phase duty command value DW is updated to “DW2” at the count-up start time t2. The U-phase duty command value DU2 is larger than the V-phase duty command value DV2. The V-phase duty command value DV2 is larger than the W-phase duty command value DW2. “DU2”, “DV2”, and “DW2” are values in the update registers allocated to the duty command values respectively as described above.

When the triangular wave TW reaches the three-phase duty command values while the triangular wave TW rises, the level of the three-phase PWM signals each go to a low level. In other words, during the count-up operation of the PWM timer, the three-phase PWM signals each go to a low level at the timing when the count value of the PWM timer matches the three-phase duty command values.

Therefore, as illustrated in FIG. 2, in the count-up period from time t2 to time t3, the U-phase PWM signal PU goes to a low level at the timing when the count value of the PWM timer matches the U-phase duty command value DU2. In the count-up period from time t2 to time t3, the V-phase PWM signal PV goes to a low level at the timing when the count value of the PWM timer matches the V-phase duty command value DV2. In the count-up period from time t2 to time t3, the W-phase PWM signal PW goes to a low level at the timing when the count value of the PWM timer matches the W-phase duty command value DW2.

The operation in the countdown period from time t3 to time t4 is the same as the operation in the countdown period from time t1 to time t2. The operation in the count-up period from time t4 to time t5 is the same as the operation in the count-up period from time t2 to time t3. The above operation is repeated in the update cycle Td of the three-phase duty command values, whereby the duty ratio of the three-phase PWM signals is individually controlled.

As can be understood from the above description, in the present embodiment, a mode in which the duty ratio of the PWM signal is controlled in a control mode so-called asymmetric center alignment mode in which the rising edge timing and the falling edge timing of the PWM signal are individually controlled is exemplified. However, the control mode of the PWM signal usable in the present invention is not limited to the asymmetric center alignment mode.

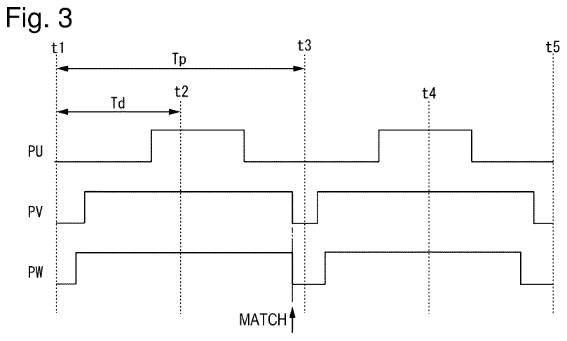

As illustrated in FIG. 3, for example, when the V-phase duty command value DV and the W-phase duty command value DW are equal among the three-phase duty command values updated at the count-up start time t2, the falling edge timing of the V-phase PWM signal PV matches the falling edge timing of the W-phase PWM signal PW in the countdown period from time t2 to time t3.

As described above, due to the potential difference (shaft voltage) between the output shaft of the three-phase motor 20 and the motor case, electrolytic corrosion may occur in the rotor bearing of the three-phase motor 20. In the example illustrated in FIG. 3, the off-timing of the V-phase PWM signal PV matches the off-timing of the W-phase PWM signal PW in the nth PWM control cycle. As a result of the study by the inventors of the present application, it has been found that, at the moment when the switching timings of the two-phase PWM signals among the three-phase PWM signals match as illustrated in FIG. 3, a large instantaneous change in the axial voltage may affect the occurrence of electrolytic corrosion.

In the example of FIG. 3, for example, when the three-phase motor 20 is in the power running state and the V-phase and W-phase currents are positive (when the current flows from the power conversion circuit 11 toward the three-phase motor 20), when the switching timings of the V-phase PWM signal PV and the W-phase PWM signal PW overlap with each other, a rapid fluctuation of the axial voltage occurs. On the other hand, in a similar state, when the V-phase current is positive and the W-phase current is negative, when the turn-off of the V-phase high side and the turn-on of the W-phase low side overlap each other, or when the turn-on of the V-phase high side and the turn-off of the W-phase low side overlap each other, a rapid fluctuation of the axial voltage occurs.

In order to solve the above technical problems, when it is predicted that the voltage fluctuations of connection terminals of at least the first phase and the second phase occur in the same direction and at the same timing among the connection terminals 13u, 13v, and 13w of the three phases connected to the three-phase motor 20, on the basis of the current update values of the three-phase duty command values, the MCU 12 according to the present embodiment shifts the occurrence timing of the voltage fluctuation of the connection terminal of the first phase determined by the current update value in a first direction by a first time, shifts the occurrence timing of the voltage fluctuation of the remaining connection terminal determined by the current update value in the first direction by a third time, and shifts the occurrence timing of the voltage fluctuation of the connection terminal of the second phase determined by the next update value or the previous update value of the three-phase duty command value in a direction opposite to the first direction by a second time.

Hereinafter, in order to facilitate understanding of the present invention, the operation of the present embodiment will be described in comparison with a conventional technique.

The conventional technique is intended to avoid simultaneous switching of a plurality of phases. Hereinafter, the conventional technique is referred to as a comparison technique. In the comparison technique, when the edge timings of two-phase PWM signals among the three-phase PWM signals match, the rising edge timing and the falling edge timing of one of the two-phase PWM signals are delayed by a predetermined time ΔT.

For example, as illustrated in FIG. 3, in the case where the duty ratios of two-phase PWM signals whose off-timings match each other are close to 100% (or close to 0%), for example, if the phase of the W-phase PWM signal PW is delayed by a predetermined time ΔT based on the comparison technique, the falling edge timing of the W-phase PWM signal PW exceeds the PWM cycle Tp, and there is a possibility that sufficient timing adjustment cannot be performed. Therefore, in this case, PWM signals cannot be generated by a normal method of generating the PWM signals by comparing the triangular wave TW with the three-phase duty command values, and the program becomes complicated.

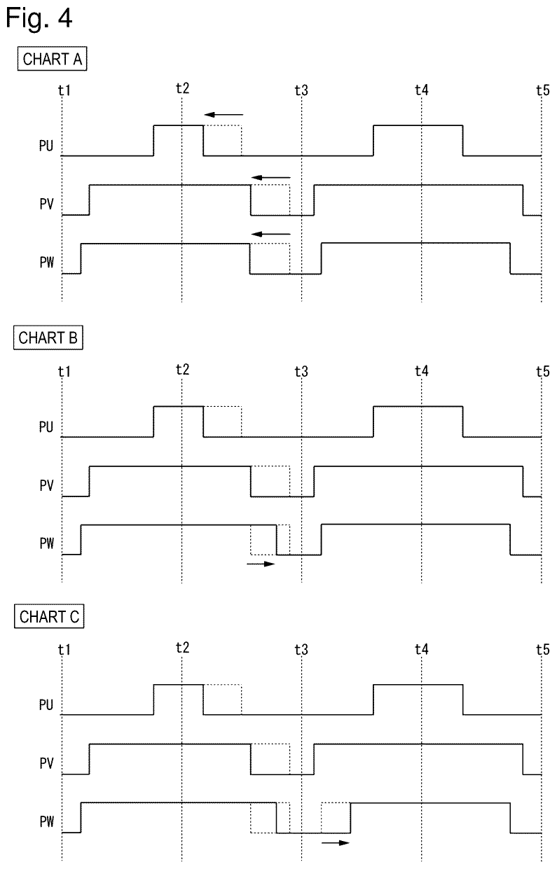

On the other hand, in the basic concept of the present invention, as illustrated in chart A of FIG. 4, first, off-timings of not only the two-phase PWM signals whose off-timings match each other but also all the three-phase PWM signals are shifted in the advance direction, thereby a margin for timing adjustment is formed. Then, as illustrated in chart B of FIG. 4, for example, the off-timing of the W-phase PWM signal PW among the two-phase PWM signals whose off-timing match each other is shifted in the delay direction. This makes it possible to avoid simultaneous switching between the V phase and the W phase. Furthermore, as illustrated in chart C of FIG. 4, in order to suppress an influence on the motor control due to the shift of the W-phase switching timing, for example, when the off-timing of the W-phase PWM signal PW is delayed, the next on-timing of the W-phase PWM signal PW is also delayed by the same amount.

According to the basic concept of the present invention as described above, even when the duty ratios of two-phase PWM signals whose off-timings (or on-timings) match each other are close to 100% (or close to 0%), the timing of the PWM signals can be adjusted within the PWM cycle Tp. Therefore, PWM signals can be generated by a normal method of generating the PWM signals by comparing the triangular wave TW with the three-phase duty command values while avoiding simultaneous switching of a plurality of phases. Hereinafter, each embodiment based on the basic concept of the present invention will be specifically described.

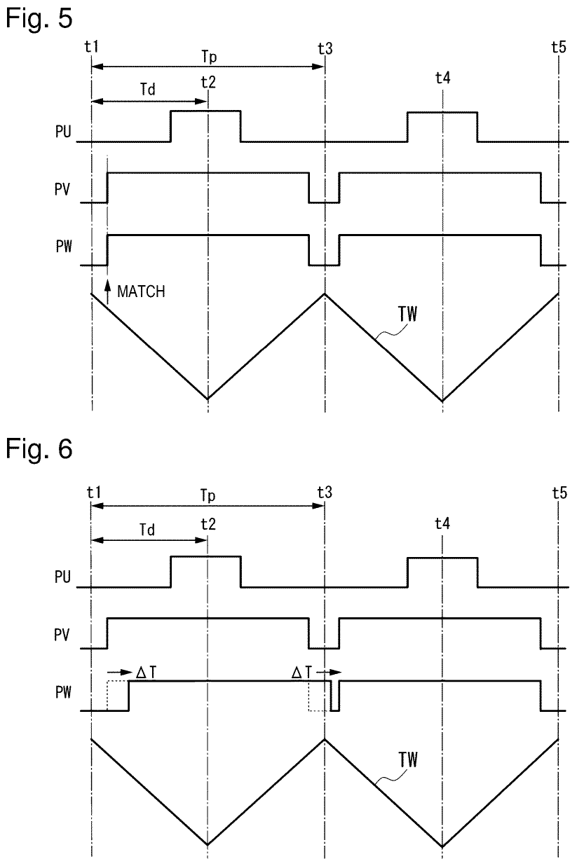

For example, as illustrated in FIG. 5, it is assumed that the rising edge timing of the V-phase PWM signal PV matches the rising edge timing of the W-phase PWM signal PW in a state where the duty ratios of the V-phase PWM signal PV and the W-phase PWM signal PW are close to 100% in the countdown period from time t1 to time t2. In this case, as illustrated in FIG. 6, for example, when the phase of the W-phase PWM signal PW is delayed by the predetermined time ΔT based on the comparison technique, there is a possibility that the falling edge timing of the W-phase PWM signal PW exceeds the PWM cycle Tp. Therefore, in this case, PWM signals cannot be generated by a normal method of generating the PWM signals by comparing the triangular wave TW with the three-phase duty command values, and the program becomes complicated.

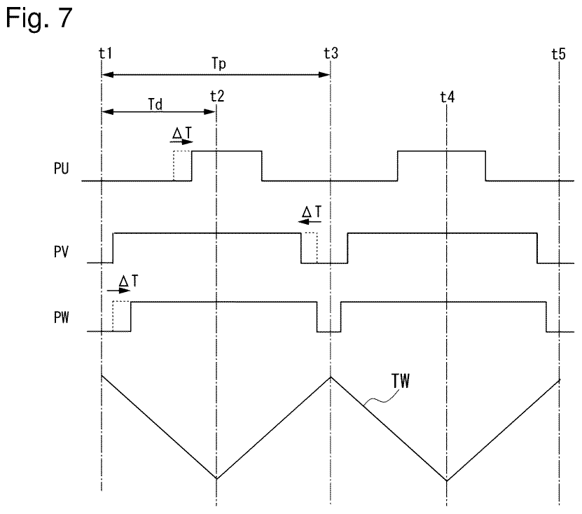

FIG. 7 is a timing chart illustrating an example of three-phase PWM signals generated according to the present embodiment in the case where the rising edge timing of the V-phase PWM signal PV matches the rising edge timing of the W-phase PWM signal PW in a state where the duty ratios of the V-phase PWM signal PV and the W-phase PWM signal PW are close to 100% in the countdown period from time t1 to time t2. In the present embodiment, when the type of the occurrence timings of the voltage fluctuations of the connection terminals of the first phase and the second phase predicted to match each other is the rising edge timing and the duty ratios of the voltage fluctuations of the connection terminals of the first phase and the second phase are included in a range from a first threshold to 100%, the MCU 12 shifts the rising edge timing of the voltage fluctuations of the remaining connection terminals determined by the current update values in the delay direction by a third time, shifts the rising edge timing of the voltage fluctuation of the connection terminal of the first phase determined by the current update value in the delay direction by a first time, and shifts the falling edge timing of the voltage fluctuation of the connection terminal of the second phase determined by the next update value or the previous update value of the three-phase duty command value in the advance direction by a second time.

Specifically, as illustrated in FIG. 7, in the countdown period from time t1 to time t2, for example, the MCU 12 shifts the rising edge timing of the W-phase PWM signal PW in the delay direction by a first time ΔT and shifts the rising edge timing of the U-phase PWM signal PU in the delay direction by a third time ΔT. This is substantially the same as advancing only the turn-on timing of the V phase by ΔT after delaying all phases by ΔT. In addition, in order to suppress an influence on the motor control due to the fact that the V-phase switching timing is substantially advanced by ΔT, the MCU 12 shifts the falling edge timing of the V-phase PWM signal PV in the advance direction by the same amount (second time ΔT) in the count-up period from time t2 to time t3. In the example of FIG. 7, the case where the first time, the second time, and the third time have the same value (ΔT) is illustrated.

As a result, even when the duty ratios of the two-phase PWM signals whose on-timings match each other are close to 100%, the timing of the PWM signals can be adjusted within the PWM cycle Tp. Therefore, PWM signals can be generated by a normal method of generating the PWM signals by comparing the triangular wave TW with the three-phase duty command values while avoiding simultaneous switching of a plurality of phases. Note that the V-phase process and the W-phase process described above may be interchanged.

Hereinafter, the operation of the MCU 12 in the example illustrated in FIG. 7 will be described in detail.

The MCU core 12a of the MCU 12 executes a command value calculation process before the countdown start time t1 which is the update timing of the three-phase duty command values, and predicts whether or not the edge timings of two-phase PWM signals among the three-phase PWM signals match, on the basis of the three-phase duty command values calculated by the command value calculation process. For example, when the V-phase duty command value DV and the W-phase duty command value DW are equal among the three-phase duty command values calculated before the countdown start time t1, the MCU core 12a predicts that the rising edge timing of the V-phase PWM signal PV matches the rising edge timing of the W-phase PWM signal PW in the countdown period from time t1 to time t2.

When the MCU core 12a predicts that the rising edge timing of the V-phase PWM signal PV matches the rising edge timing of the W-phase PWM signal PW, and determines that duty ratios of the V-phase and the W phase are included in a range from the first threshold to 100%, the MCU core performs a correction process of subtracting a value corresponding to the third time ΔT from the calculated value of the U-phase duty command value DU, and performs a correction process of subtracting a value corresponding to the first time ΔT to the calculated value of the W-phase duty command value DW. The MCU core 12a outputs the V-phase duty command value DV calculated by the command value calculation process and the U-phase duty command value DU and the W-phase duty command value DW subjected to the correction process, to the PWM module 12b.

As described above, the three-phase duty command values input from the MCU core 12a to the PWM module 12b before the countdown start time t1 are temporarily stored in the buffer registers. Then, when the countdown start time t1 arrives, the three-phase duty command values stored in the buffer registers are transferred to the update registers. As described above, at the countdown start time t1, the contents of the update registers are updated to the new three-phase duty command values. As a result, as illustrated in FIG. 7, among the three-phase PWM signals generated by PWM module 12b in the countdown period from time t1 to time t2, the rising edge timing of the W-phase PWM signal PW is delayed by the first time ΔT, and the rising edge timing of the U-phase PWM signal PU is delayed by third time ΔT.

The MCU core 12a executes the command value calculation process again before the count-up start time t2 which is the next update timing of the three-phase duty command values. The MCU core 12a performs a compensation process on the duty command value subjected to the correction process at the time of execution of the previous command value calculation process, among the three-phase duty command values calculated by the current command value calculation process. For example, the MCU core 12a performs a compensation process of adding a value corresponding to the second time ΔT to the calculated value of the V-phase duty command value DV among the three-phase duty command values calculated by the current command value calculation process. The MCU core 12a outputs the U-phase duty command value DU and the W-phase duty command value DW calculated by the current command value calculation process and the V-phase duty command value DV subjected to the compensation process, to the PWM module 12b.

As described above, the three-phase duty command values input from the MCU core 12a to the PWM module 12b before the count-up start time t2 are temporarily stored in the buffer registers. Then, when the count-up start time t2 arrives, the three-phase duty command values stored in the buffer registers are transferred to the update registers. As described above, at the count-up start time t2, the contents of the update registers are updated to the new three-phase duty command values. As a result, as illustrated in FIG. 7, among the three-phase PWM signals generated by the PWM module 12b in the count-up period from time t2 to time t3, the falling edge timing of the V-phase PWM signal PV is advanced by the second time ΔT.

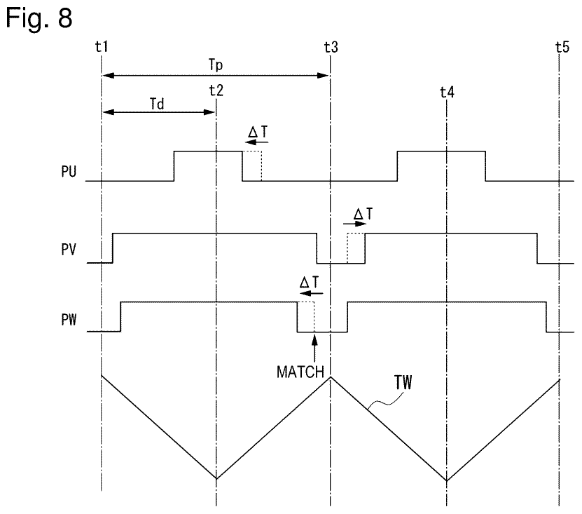

FIG. 8 is a timing chart illustrating an example of three-phase PWM signals generated according to the present embodiment in the case where the falling edge timing of the V-phase PWM signal PV matches the falling edge timing of the W-phase PWM signal PW in a state where the duty ratios of the V-phase PWM signal PV and the W-phase PWM signal PW are close to 100% in the countdown period from time t1 to time t2. In the present embodiment, when the type of the occurrence timings of the voltage fluctuations of the connection terminals of the first phase and the second phase predicted to match each other is a falling edge timing, and the duty ratios of the voltage fluctuations of the connection terminals of the first phase and the second phase are included in a range from the first threshold to 100%, the MCU 12 shifts the falling edge timing of the voltage fluctuations of the remaining connection terminals determined by the current update values in the advance direction by a third time, shifts the falling edge timing of the voltage fluctuation of the connection terminal of the first phase determined by the current update value in the advance direction by a first time, and shifts the rising edge timing of the voltage fluctuation of the connection terminal of the second phase determined by the next update value or the previous update value of the three-phase duty command value in the delay direction by a second time.

Specifically, as illustrated in FIG. 8, in the count-up period from time t2 to time t3, for example, the MCU 12 shifts the falling edge timing of the W-phase PWM signal PW in the advance direction by the first time ΔT and shifts the falling edge timing of the U-phase PWM signal PU in the advance direction by the third time ΔT. This is substantially the same as the case where only the turn-off timing of the V phase is delayed by ΔT after all phases are advanced by ΔT. In addition, in order to suppress an influence on the motor control due to the fact that the V-phase switching timing is substantially delayed by ΔT, the MCU 12 shifts the rising edge timing of the V-phase PWM signal PV in the delay direction by the same amount (second time ΔT) in the countdown period from time t3 to time t4.

As a result, even when the duty ratios of the two-phase PWM signals whose off-timings match each other are close to 100%, the timing of the PWM signals can be adjusted within the PWM cycle Tp. Therefore, the PWM signals can be generated by a normal method of generating the PWM signals by comparing the triangular wave TW with the three-phase duty command values while avoiding simultaneous switching of a plurality of phases. Note that the V-phase process and the W-phase process described above may be interchanged.

Hereinafter, the operation of the MCU 12 in the example illustrated in FIG. 8 will be described in detail.

The MCU core 12a of the MCU 12 executes a command value calculation process before the count-up start time t2 which is the update timing of the three-phase duty command values, and predicts whether or not the edge timings of two-phase PWM signals among the three-phase PWM signals match, on the basis of the three-phase duty command values calculated by the command value calculation process. For example, when the V-phase duty command value DV and the W-phase duty command value DW are equal among the three-phase duty command values calculated before the count-up start time t2, the MCU core 12a predicts that the falling edge timing of the V-phase PWM signal PV matches the falling edge timing of the W-phase PWM signal PW in the count-up period from time t2 to time t3.

When the MCU core 12a predicts that the falling edge timing of the V-phase PWM signal PV matches the falling edge timing of the W-phase PWM signal PW, and determines that the duty ratios of the V-phase and the W-phase are included in a range from the first threshold to 100%, the MCU core performs a correction process of subtracting a value corresponding to the third time ΔT from the calculated value of the U-phase duty command value DU, and performs a correction process of subtracting a value corresponding to the first time ΔT from the calculated value of the W-phase duty command value DW. The MCU core 12a outputs the V-phase duty command value DV calculated by the command value calculation process and the U-phase duty command value DU and the W-phase duty command value DW subjected to the correction process, to the PWM module 12b.

As described above, the three-phase duty command values input from the MCU core 12a to the PWM module 12b before the count-up start time t2 are temporarily stored in the buffer registers. Then, when the count-up start time t2 arrives, the three-phase duty command values stored in the buffer registers are transferred to the update registers. As described above, at the count-up start time t2, the contents of the update registers are updated to the new three-phase duty command values. As a result, as illustrated in FIG. 8, among the three-phase PWM signals generated by the PWM module 12b in the count-up period from time t2 to time t3, the falling edge timing of the W-phase PWM signal PW is advanced by the first time ΔT, and the falling edge timing of the U-phase PWM signal PU is advanced by the third time ΔT.

The MCU core 12a executes the command value calculation process again before the countdown start time t3 which is the next update timing of the three-phase duty command values. The MCU core 12a performs a compensation process on the duty command value subjected to the correction process at the time of execution of the previous command value calculation process, among the three-phase duty command values calculated by the current command value calculation process. For example, the MCU core 12a performs a compensation process of subtracting a value corresponding to the second time ΔT from the calculated value of the V-phase duty command value DV among the three-phase duty command values calculated by the current command value calculation process. The MCU core 12a outputs the U-phase duty command value DU and the W-phase duty command value DW calculated by the current command value calculation process and the V-phase duty command value DV subjected to the compensation process, to the PWM module 12b.

As described above, the three-phase duty command values input from the MCU core 12a to the PWM module 12b before the countdown start time t3 are temporarily stored in the buffer registers. Then, when the countdown start time t3 arrives, the three-phase duty command values stored in the buffer registers are transferred to the update registers. As described above, at the countdown start time t3, the contents of the update registers are updated to the new three-phase duty command values. As a result, as illustrated in FIG. 8, among the three-phase PWM signals generated by the PWM module 12b in the countdown period from time t3 to time t4, the rising edge timing of the V-phase PWM signal PV is delayed by the second time ΔT.

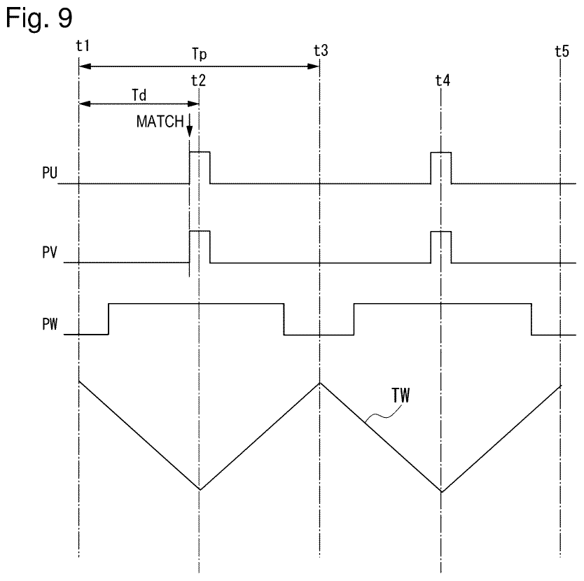

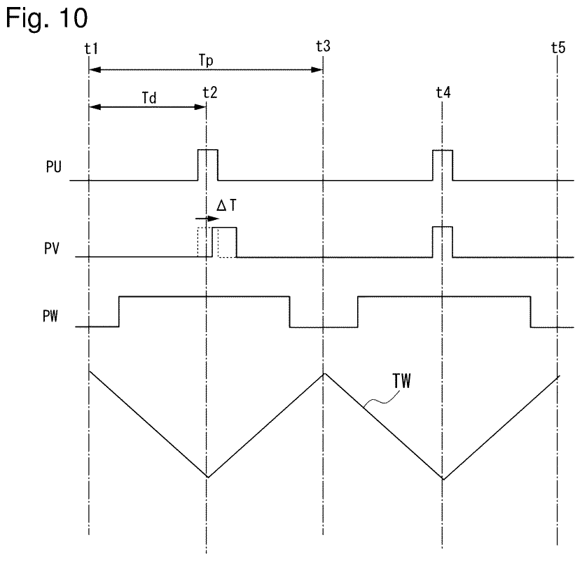

Next, as illustrated in FIG. 9, it is assumed that the rising edge timing of the U-phase PWM signal matches the rising edge timing of the V-phase PWM signal in a state where the duty ratios of the U-phase PWM signal and the V-phase PWM signal are close to 0% in the countdown period from time t1 to time t2. In this case, as illustrated in FIG. 10, for example, when the phase of the V-phase PWM signal PV is delayed by the predetermined time ΔT based on the comparison technique, there is a possibility that the rising edge timing of the V-phase PWM signal PV exceeds the valley of the triangular wave TW to the rear side. Therefore, in this case, PWM signals cannot be generated by a normal method of generating the PWM signals by comparing the triangular wave TW with the three-phase duty command values, and the program becomes complicated.

Although not illustrated, conversely, when the phase of the V-phase PWM signal PW is advanced by the predetermined time ΔT, there is a possibility that the falling edge timing of the V-phase PWM signal PV exceeds the valley of the triangular wave TW to the front side. Therefore, even in this case, PWM signals cannot be generated by a normal method of generating the PWM signals by comparing the triangular wave TW with the three-phase duty command values, and the program becomes complicated.

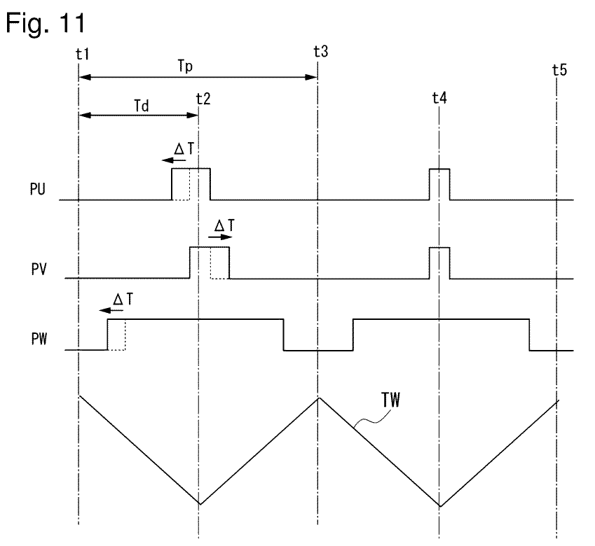

FIG. 11 is a timing chart illustrating an example of three-phase PWM signals generated by the present embodiment when a rising edge timing of the U-phase PWM signal matches a rising edge timing of the V-phase PWM signal in a state where the duty ratios of the U-phase PWM signal and the V-phase PWM signal are close to 0%. In the present embodiment, when the type of the occurrence timings of the voltage fluctuations of the connection terminals of the first phase and the second phase predicted to match each other is a rising edge timing, and the duty ratios of the voltage fluctuations of the connection terminals of the first phase and the second phase are included in a range from the second threshold to 0%, the MCU 12 shifts the rising edge timing of the voltage fluctuations of the remaining connection terminals determined by the current update values in the advance direction by a third time, shifts the rising edge timing of the voltage fluctuation of the connection terminal of the first phase determined by the current update value in the advance direction by a first time, and shifts the falling edge timing of the voltage fluctuation of the connection terminal of the second phase determined by the next update value or the previous update value of the three-phase duty command value in the delay direction by a second time.

Specifically, as illustrated in FIG. 11, during the countdown period from time t1 to time t2, for example, the MCU 12 shifts the rising edge timing of the U-phase PWM signal PU in the advance direction by the first time ΔT and shifts the rising edge timing of the W-phase PWM signal PW in the advance direction by the third time ΔT. This is substantially the same as delaying only the turn-on timing of the V phase by ΔT after advancing all phases by ΔT. In addition, in order to suppress an influence on the motor control due to the fact that the V-phase switching timing is substantially delayed by ΔT, the MCU 12 shifts the falling edge timing of the V-phase PWM signal PV in the delay direction by the same amount (second time ΔT) in the count-up period from time t2 to time t3.

As a result, even when the duty ratios of the two-phase PWM signals whose on-timings match each other are close to 0%, the timing of the PWM signals can be adjusted within the PWM cycle Tp. Therefore, the PWM signals can be generated by a normal method of generating the PWM signals by comparing the triangular wave TW with the three-phase duty command values while avoiding simultaneous switching of a plurality of phases. Note that the U-phase process and the V-phase process described above may be interchanged.

Hereinafter, the operation of the MCU 12 in the example illustrated in FIG. 11 will be described in detail.

The MCU core 12a of the MCU 12 executes a command value calculation process before the countdown start time t1 which is the update timing of the three-phase duty command values, and predicts whether or not the edge timings of two-phase PWM signals among the three-phase PWM signals match, on the basis of the three-phase duty command values calculated by the command value calculation process. For example, when the U-phase duty command value DU and the V-phase duty command value DV are equal among the three-phase duty command values calculated before the countdown start time t1, the MCU core 12a predicts that the rising edge timing of the U-phase PWM signal PU matches the rising edge timing of the V-phase PWM signal PV in the countdown period from time t1 to time t2.

When the MCU core 12a predicts that the rising edge timing of the U-phase PWM signal PU matches the rising edge timing of the V-phase PWM signal PV, and determines that the duty ratios of the U phase and the V phase are included in a range from the second threshold to 0%, the MCU core performs a correction process of adding a value corresponding to the third time ΔT to the calculated value of the W-phase duty command value DW, and performs a correction process of adding a value corresponding to the first time ΔT to the calculated value of the U-phase duty command value DU. The MCU core 12a outputs the V-phase duty command value DV calculated by the command value calculation process and the U-phase duty command value DU and the W-phase duty command value DW subjected to the correction process, to the PWM module 12b.

As described above, the three-phase duty command values input from the MCU core 12a to the PWM module 12b before the countdown start time t1 are temporarily stored in the buffer registers. Then, when the countdown start time t1 arrives, the three-phase duty command values stored in the buffer registers are transferred to the update registers. As described above, at the countdown start time t1, the contents of the update registers are updated to the new three-phase duty command values. As a result, as illustrated in FIG. 11, among the three-phase PWM signals generated by the PWM module 12b in the countdown period from time t1 to time t2, the rising edge timing of the U-phase PWM signal PW is delayed by the first time ΔT, and the rising edge timing of the W-phase PWM signal PW is advanced by the third time ΔT.

The MCU core 12a executes the command value calculation process again before the count-up start time t2 which is the next update timing of the three-phase duty command values. The MCU core 12a performs a compensation process on the duty command value subjected to the correction process at the time of execution of the previous command value calculation process, among the three-phase duty command values calculated by the current command value calculation process. For example, the MCU core 12a performs a compensation process of adding a value corresponding to the second time ΔT to the calculated value of the V-phase duty command value DV among the three-phase duty command values calculated by the current command value calculation process. The MCU core 12a outputs the U-phase duty command value DU and the W-phase duty command value DW calculated by the current command value calculation process and the V-phase duty command value DV subjected to the compensation process, to the PWM module 12b.

As described above, the three-phase duty command values input from the MCU core 12a to the PWM module 12b before the count-up start time t2 are temporarily stored in the buffer registers. Then, when the count-up start time t2 arrives, the three-phase duty command values stored in the buffer registers are transferred to the update registers. As described above, at the count-up start time t2, the contents of the update registers are updated to the new three-phase duty command values. As a result, as illustrated in FIG. 11, among the three-phase PWM signals generated by the PWM module 12b in the count-up period from time t2 to time t3, the falling edge timing of the V-phase PWM signal PV is delayed by the second time ΔT.

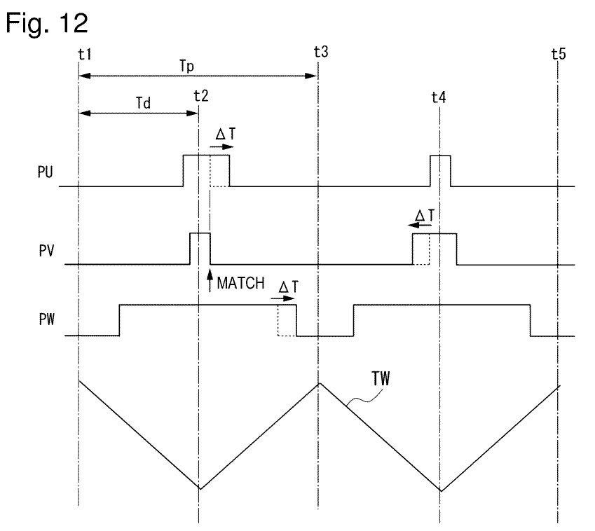

FIG. 12 is a timing chart illustrating an example of three-phase PWM signals generated by the present embodiment when a falling edge timing of the U-phase PWM signal matches a falling edge timing of the V-phase PWM signal in a state where the duty ratios of the U-phase PWM signal and the V-phase PWM signal are close to 0%. In the present embodiment, when the type of the occurrence timings of the voltage fluctuations of the connection terminals of the first phase and the second phase predicted to match each other is a falling edge timing, and the duty ratios of the voltage fluctuations of the connection terminals of the first phase and the second phase are included in the range from the second threshold to 0%, the MCU 12 shifts the rising edge timing of the voltage fluctuations of the remaining connection terminals determined by the current update value in the delay direction by a third time, shifts the falling edge timing of the voltage fluctuation of the connection terminal of the first phase determined by the current update value in the delay direction by a first time, and shifts the rising edge timing of the voltage fluctuation of the connection terminal of the second phase determined by the next update value or the previous update value of the three-phase duty command value in the advance direction by a second time.

Specifically, as illustrated in FIG. 12, in the count-up period from time t2 to time t3, for example, the MCU 12 shifts the falling edge timing of the U-phase PWM signal PU in the delay direction by the first time ΔT and shifts the falling edge timing of the W-phase PWM signal PW in the delay direction by the third time ΔT. This is substantially the same as the case where only the turn-off timing of the V phase is advanced by ΔT after all phases are delayed by ΔT. In addition, in order to suppress an influence on the motor control due to the fact that the V-phase switching timing is substantially advanced by ΔT, the MCU 12 shifts the rising edge timing of the V-phase PWM signal PV in the advance direction by the same amount (second time ΔT) in the countdown period from time t3 to time t4.

As a result, even when the duty ratios of the two-phase PWM signals whose off-timings match each other are close to 0%, the timing of the PWM signals can be adjusted within the PWM cycle Tp. Therefore, the PWM signals can be generated by a normal method of generating the PWM signals by comparing the triangular wave TW with the three-phase duty command values while avoiding simultaneous switching of a plurality of phases. Note that the U-phase process and the V-phase process described above may be interchanged.

Hereinafter, the operation of the MCU 12 in the example illustrated in FIG. 12 will be described in detail.

The MCU core 12a of the MCU 12 executes a command value calculation process before the count-up start time t2 which is the update timing of the three-phase duty command values, and predicts whether or not the edge timings of two-phase PWM signals among the three-phase PWM signals match, on the basis of the three-phase duty command values calculated by the command value calculation process. For example, when the U-phase duty command value DU and the V-phase duty command value DV are equal among the three-phase duty command values calculated before the count-up start time t2, the MCU core 12a predicts that the falling edge timing of the U-phase PWM signal PU matches the falling edge timing of the V-phase PWM signal PV in the count-up period from time t2 to time t3.

When the MCU core 12a predicts that the falling edge timing of the U-phase PWM signal PU matches the falling edge timing of the V-phase PWM signal PV, and determines that the duty ratios of the U phase and the V phase are included in the range from the second threshold to 0%, the MCU core performs a correction process of adding a value corresponding to the third time ΔT to the calculated value of the W-phase duty command value DW, and performs a correction process of adding a value corresponding to the first time ΔT to the calculated value of the U-phase duty command value DU. The MCU core 12a outputs the V-phase duty command value DV calculated by the command value calculation process and the U-phase duty command value DU and the W-phase duty command value DW subjected to the correction process, to the PWM module 12b.

As described above, the three-phase duty command values input from the MCU core 12a to the PWM module 12b before the count-up start time t2 are temporarily stored in the buffer registers. Then, when the count-up start time t2 arrives, the three-phase duty command values stored in the buffer registers are transferred to the update registers. As described above, at the count-up start time t2, the contents of the update registers are updated to the new three-phase duty command values. As a result, as illustrated in FIG. 12, among the three-phase PWM signals generated by the PWM module 12b in the count-up period from time t2 to time t3, the falling edge timing of the U-phase PWM signal PW is delayed by the first time ΔT, and the falling edge timing of the W-phase PWM signal PW is delayed by the third time ΔT.

The MCU core 12a executes the command value calculation process again before the countdown start time t3 which is the next update timing of the three-phase duty command values. The MCU core 12a performs a compensation process on the duty command value subjected to the correction process at the time of execution of the previous command value calculation process, among the three-phase duty command values calculated by the current command value calculation process. For example, the MCU core 12a performs a compensation process of adding a value corresponding to the second time ΔT to the calculated value of the V-phase duty command value DV among the three-phase duty command values calculated by the current command value calculation process. The MCU core 12a outputs the U-phase duty command value DU and the W-phase duty command value DW calculated by the current command value calculation process and the V-phase duty command value DV subjected to the compensation process, to the PWM module 12b.

As described above, the three-phase duty command values input from the MCU core 12a to the PWM module 12b before the countdown start time t3 are temporarily stored in the buffer registers. Then, when the countdown start time t3 arrives, the three-phase duty command values stored in the buffer registers are transferred to the update registers. As described above, at the countdown start time t3, the contents of the update registers are updated to the new three-phase duty command values. As a result, as illustrated in FIG. 12, among the three-phase PWM signals generated by the PWM module 12b in the count-up period from time t3 to time t4, the rising edge timing of the V-phase PWM signal PV is advanced by the second time ΔT.

The above embodiment has described the case where the PWM signals are generated in the asymmetric center alignment mode in which the three-phase duty command values are updated in both the peak and the valley of the triangular wave TW as an example. However, in the case where the PWM signals are generated in the normal center alignment mode in which the three-phase duty command values are updated only in one of the peak and the valley of the triangular wave TW, duty compensation for which the timing is shifted at the current update time may be performed at the next update time.

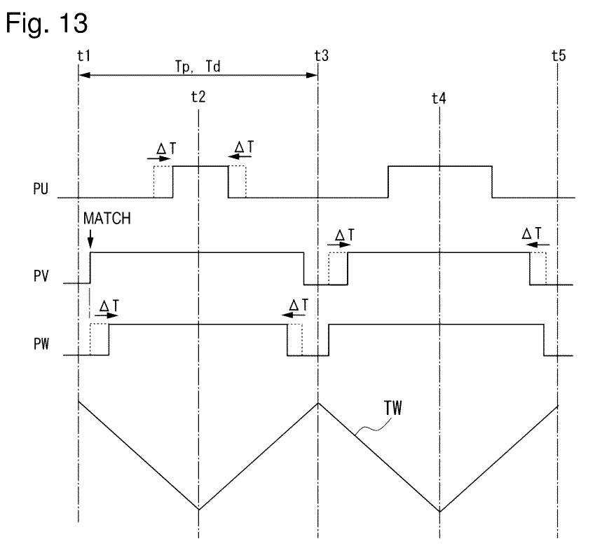

FIG. 13 is a timing chart illustrating an example of three-phase PWM signals generated by the normal center alignment mode when a rising edge timing of the V-phase PWM signal matches a rising edge timing of the W-phase PWM signal in a state where the duty ratios of the V-phase PWM signal and the W-phase PWM signal are close to 100%. FIG. 13 illustrates the case where the three-phase duty command values are updated at the peaks of the triangular wave TW, that is, at times t1, t3, and t5. In this case, as illustrated in FIG. 13, the duty of the U phase and the W phase is shortened by 2ΔT in the period from time t1 to time t3. This corresponds to the fact that the duty is extended by 2ΔT only for the V phase in the period from time t1 to time t3. Therefore, in this case, the duty of the V phase is shortened by 2ΔT in the period from time t3 to time t5.

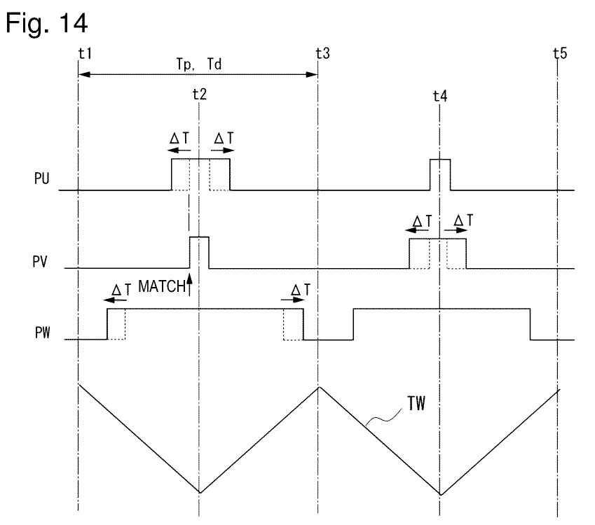

FIG. 14 is a timing chart illustrating an example of three-phase PWM signals generated by the normal center alignment mode when a rising edge timing of the U-phase PWM signal matches a rising edge timing of the V-phase PWM signal in a state where the duty ratios of the U-phase PWM signal and the V-phase PWM signal are close to 0%. FIG. 14 illustrates the case where the three-phase duty command values are updated at the peaks of the triangular wave TW, that is, at times t1, t3, and t5. In this case, as illustrated in FIG. 14, the duty of the U phase and the W phase is extended by 2ΔT in the period from time t1 to time t3. This corresponds to the fact that the duty is shortened by 2ΔT only for the V phase in the period from time t1 to time t3. Therefore, in this case, the duty of the V phase is extended by 2ΔT in the period from time t3 to time t5.

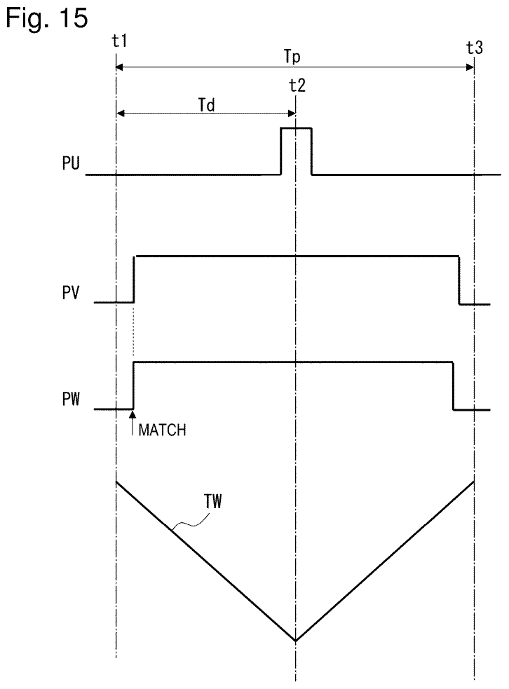

Next, as illustrated in FIG. 15, it is assumed that a rising edge timing of the V-phase PWM signal matches a rising edge timing of the W-phase PWM signal in a state where the duty ratio of the U-phase PWM signal is close to 0% and the duty ratios of the V-phase PWM signal and the W-phase PWM signal are close to 100%. Even in this case, in order to avoid simultaneous switching of a plurality of phases based on the comparison technique, PWM signals cannot be generated by the normal method of generating the PWM signals by comparing the triangular wave TW with the three-phase duty command values, and the program becomes complicated.

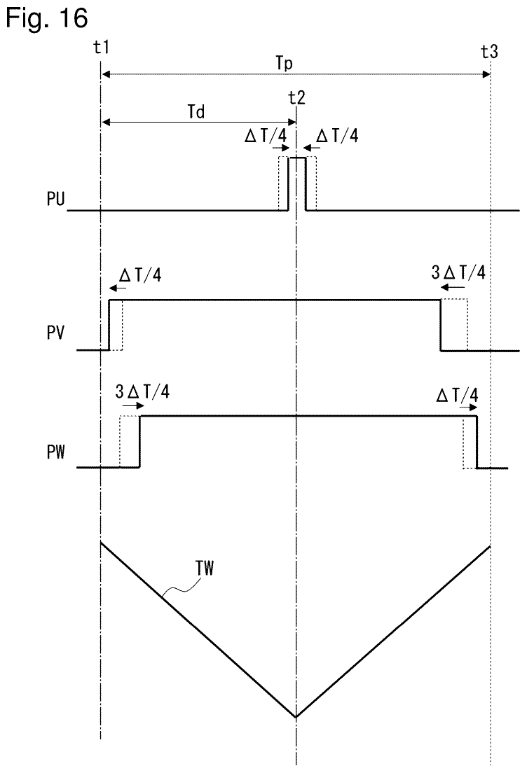

FIG. 16 is a timing chart illustrating an example of three-phase PWM signals generated by the present embodiment when a rising edge timing of the V-phase PWM signal matches a rising edge timing of the W-phase PWM signal in a state where the duty ratio of the U-phase PWM signal is close to 0% and the duty ratios of the V-phase PWM signal and the W-phase PWM signal are close to 100%.

In the present embodiment, when the type of the voltage fluctuations of the connection terminals of the first phase and the second phase predicted to match each other is a rising edge timing, the duty ratios of the voltage fluctuations of the connection terminals of the first phase and the second phase are included in the range from the first threshold to 100%, and the duty ratio of the voltage fluctuation of at least one of the remaining connection terminals is included in the range from the second threshold to 0%, the MCU 12 shifts the rising edge timing of the voltage fluctuation of the connection terminal of the first phase determined by the current update value in the delay direction by the first time, shifts the rising edge timing of the voltage fluctuation of the connection terminal of the second phase determined by the current update value in the advance direction by the fourth time, and shifts the rising edge timing of the voltage fluctuation of the remaining connection terminal determined by the current update value in the delay direction by the third time.

Further, the MCU 12 shifts the falling edge timing of the voltage fluctuation of the connection terminal of the second phase determined by the next update value or the previous update value of the three-phase duty command value in the advance direction by a second time, shifts the falling edge timing of the voltage fluctuation of the connection terminal of the first phase determined by the next update value or the previous update value in the delay direction by a fifth time, and shifts the falling edge timing of the voltage fluctuation of the remaining connection terminal determined by the next update value or the previous update value in the advance direction by a sixth time.

Specifically, as illustrated in FIG. 16, in the countdown period from time t1 to time t2, for example, the MCU 12 shifts the rising edge timing of the W-phase PWM signal PW in the delay direction by a first time (3ΔT/4), shifts the rising edge timing of the V-phase PWM signal PV in the advance direction by a fourth time (ΔT/4), and shifts the rising edge timing of the U-phase PWM signal PU in the delay direction by a third time (ΔT/4). Further, in the count-up period from time t2 to time t3, the MCU 12 shifts the falling edge timing of the V-phase PWM signal PV in the advance direction by a second time (3ΔT/4), shifts the falling edge timing of the W-phase PWM signal PW in the delay direction by a fifth time (ΔT/4), and shifts the falling edge timing of the U-phase PWM signal PU in the advance direction by a sixth time (ΔT/4).

As a result, even when the duty ratios of the two-phase PWM signals whose on-timings match each other are close to 100%, the timing of the PWM signals can be adjusted within the PWM cycle Tp. Therefore, PWM signals can be generated by a normal method of generating the PWM signals by comparing the triangular wave TW with the three-phase duty command values while avoiding simultaneous switching of a plurality of phases, and the shift amount of the edges close to the peak and the valley of the triangular wave TW can be suppressed. In the example of FIG. 16, the on-time of all the phases is uniformly shortened by ΔT/2. The V-phase process and the W-phase process described above may be interchanged.

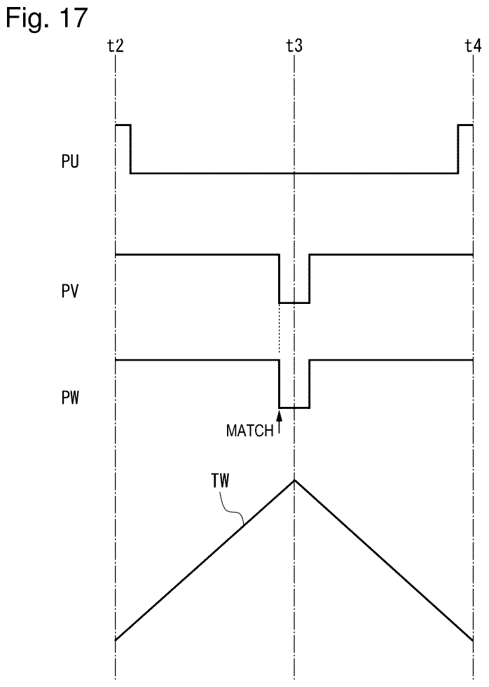

Next, as illustrated in FIG. 17, it is assumed that a falling edge timing of the V-phase PWM signal matches a falling edge timing of the W-phase PWM signal in a state where the duty ratio of the U-phase PWM signal is close to 0% and the duty ratios of the V-phase PWM signal and the W-phase PWM signal are close to 100%. Even in this case, in order to avoid simultaneous switching of a plurality of phases based on the comparison technique, PWM signals cannot be generated by the normal method of generating the PWM signals by comparing the triangular wave TW with the three-phase duty command values, and the program becomes complicated.

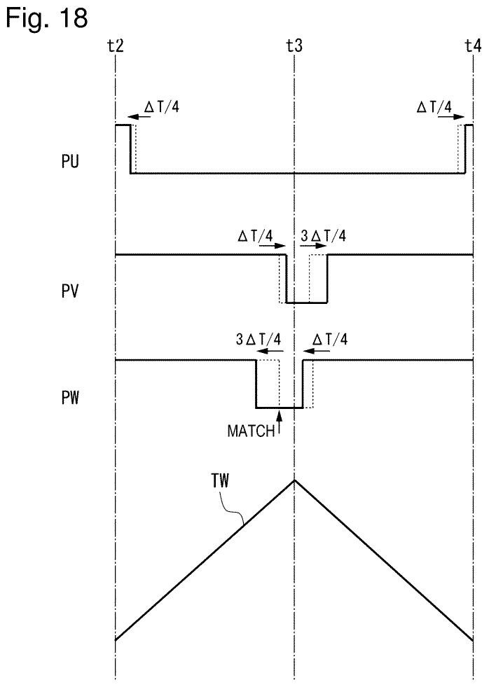

FIG. 18 is a timing chart illustrating an example of three-phase PWM signals generated by the present embodiment when a falling edge timing of the V-phase PWM signal matches a falling edge timing of the W-phase PWM signal in a state where the duty ratio of the U-phase PWM signal is close to 0% and the duty ratios of the V-phase PWM signal and the W-phase PWM signal are close to 100%.

In the present embodiment, when the type of the voltage fluctuations of the connection terminals of the first phase and the second phase predicted to match each other is a falling edge timing, the duty ratios of the voltage fluctuations of the connection terminals of the first phase and the second phase are included in a range from the first threshold to 100%, and the duty ratio of the voltage fluctuation of at least one of the remaining connection terminals is included in a range from the second threshold to 0%, the MCU 12 shifts the falling edge timing of the voltage fluctuation of the connection terminal of the first phase determined by the current update value in the advance direction by the first time, shifts the falling edge timing of the voltage fluctuation of the connection terminal of the second phase determined by the current update value in the delay direction by the fourth time, and shifts the falling edge timing of the voltage fluctuation of the remaining connection terminal determined by the current update value in the advance direction by the third time.

Further, the MCU 12 shifts the rising edge timing of the voltage fluctuation of the connection terminal of the second phase determined by the next update value or the previous update value of the three-phase duty command value in the delay direction by the second time, shifts the rising edge timing of the voltage fluctuation of the connection terminal of the first phase determined by the next update value or the previous update value in the advance direction by the fifth time, and shifts the rising edge timing of the voltage fluctuation of the remaining connection terminal determined by the next update value or the previous update value in the delay direction by the sixth time.

Specifically, as illustrated in FIG. 18, in the count-up period from time t2 to time t3, for example, the MCU 12 shifts the falling edge timing of the W-phase PWM signal PW in the advance direction by a first time (3ΔT/4), shifts the falling edge timing of the V-phase PWM signal PV in the delay direction by a fourth time (ΔT/4), and shifts the falling edge timing of the U-phase PWM signal PU in the advance direction by a third time (ΔT/4). Further, in the countdown period from time t3 to time t4, the MCU 12 shifts the rising edge timing of the V-phase PWM signal PV in the delay direction by a second time (3ΔT/4), shifts the rising edge timing of the W-phase PWM signal PW in the advance direction by a fifth time (ΔT/4), and shifts the rising edge timing of the U-phase PWM signal PU in the delay direction by a sixth time (ΔT/4).

As a result, even when the duty ratios of the two-phase PWM signals whose off-timings match each other are close to 100%, the timing of the PWM signals can be adjusted within the PWM cycle Tp. Therefore, PWM signals can be generated by a normal method of generating the PWM signals by comparing the triangular wave TW with the three-phase duty command values while avoiding simultaneous switching of a plurality of phases, and the shift amount of the edges close to the peak and the valley of the triangular wave TW can be suppressed. In the example of FIG. 18, the on-time of all the phases is uniformly shortened by ΔT/2. The V-phase process and the W-phase process described above may be interchanged.

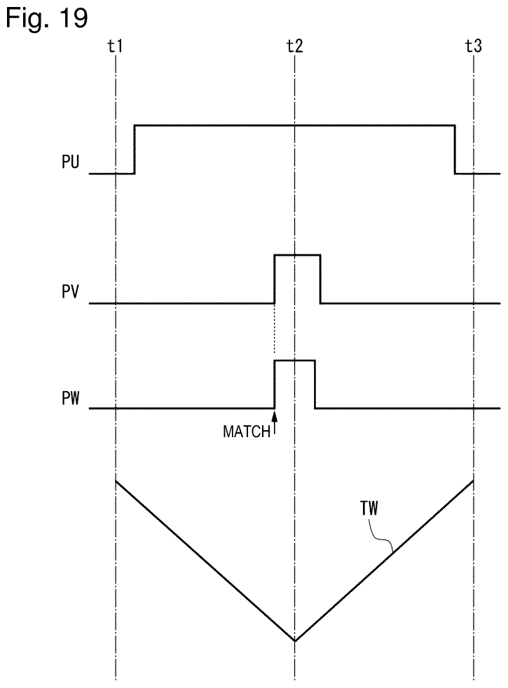

Next, as illustrated in FIG. 19, it is assumed that a rising edge timing of the V-phase PWM signal matches a rising edge timing of the W-phase PWM signal in a state where the duty ratio of the U-phase PWM signal is close to 100% and the duty ratios of the V-phase PWM signal and the W-phase PWM signal are close to 0%. Even in this case, in order to avoid simultaneous switching of a plurality of phases based on the comparison technique, PWM signals cannot be generated by the normal method of generating the PWM signals by comparing the triangular wave TW with the three-phase duty command values, and the program becomes complicated.

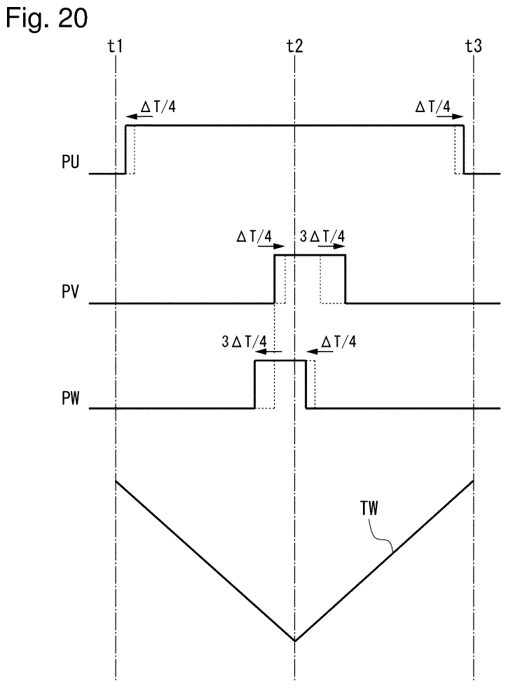

FIG. 20 is a timing chart illustrating an example of three-phase PWM signals generated by the present embodiment when a rising edge timing of the V-phase PWM signal matches a rising edge timing of the W-phase PWM signal in a state where the duty ratio of the U-phase PWM signal is close to 100% and the duty ratios of the V-phase PWM signal and the W-phase PWM signal are close to 0%.

In the present embodiment, when the type of the voltage fluctuations of the connection terminals of the first phase and the second phase predicted to match each other is a rising edge timing, the duty ratios of the voltage fluctuations of the connection terminals of the first phase and the second phase are included in a range from the second threshold to 0%, and the duty ratio of the voltage fluctuation of at least one of the remaining connection terminals is included in a range from the first threshold to 100%, the MCU 12 shifts the rising edge timing of the voltage fluctuation of the connection terminal of the first phase determined by the current update value in the advance direction by the first time, shifts the rising edge timing of the voltage fluctuation of the connection terminal of the second phase determined by the current update value in the delay direction by the fourth time, and shifts the rising edge timing of the voltage fluctuation of the remaining connection terminal determined by the current update value in the advance direction by the third time.

Further, the MCU 12 shifts the falling edge timing of the voltage fluctuation of the connection terminal of the second phase determined by the next update value or the previous update value of the three-phase duty command value in the delay direction by the second time, shifts the falling edge timing of the voltage fluctuation of the connection terminal of the first phase determined by the next update value or the previous update value in the advance direction by the fifth time, and shifts the falling edge timing of the voltage fluctuation of the remaining connection terminal determined by the next update value or the previous update value in the delay direction by the sixth time.

Specifically, as illustrated in FIG. 20, in the countdown period from time t1 to time t2, for example, the MCU 12 shifts the rising edge timing of the W-phase PWM signal PW in the advance direction by a first time (3ΔT/4), shifts the rising edge timing of the V-phase PWM signal PV in the delay direction by a fourth time (ΔT/4), and shifts the rising edge timing of the U-phase PWM signal PU in the advance direction by a third time (ΔT/4). Further, in the count-up period from time t2 to time t3, the MCU 12 shifts the falling edge timing of the V-phase PWM signal PV in the delay direction by a second time (3ΔT/4), shifts the falling edge timing of the W-phase PWM signal PW in the advance direction by a fifth time (ΔT/4), and shifts the falling edge timing of the U-phase PWM signal PU in the delay direction by a sixth time (ΔT/4).

As a result, even when the duty ratios of the two-phase PWM signals whose on-timings match each other are close to 0%, the timing of the PWM signals can be adjusted within the PWM cycle Tp. Therefore, PWM signals can be generated by a normal method of generating the PWM signals by comparing the triangular wave TW with the three-phase duty command values while avoiding simultaneous switching of a plurality of phases, and the shift amount of the edges close to the peak and the valley of the triangular wave TW can be suppressed. In the example of FIG. 20, the on-time of all the phases is uniformly extended by ΔT/2. The V-phase process and the W-phase process described above may be interchanged.

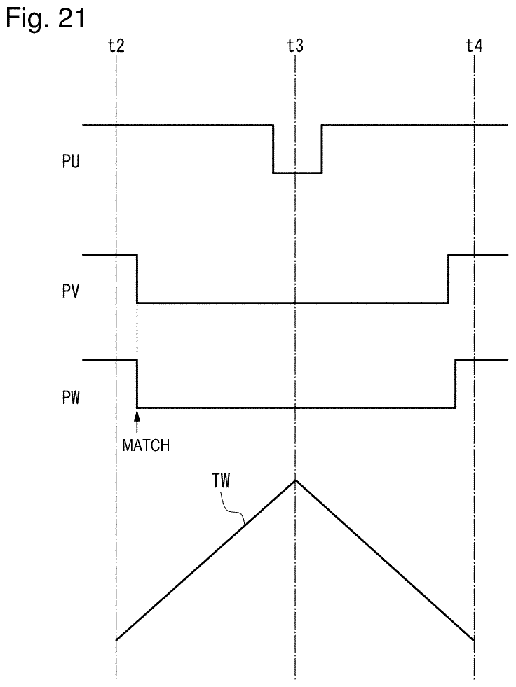

Next, as illustrated in FIG. 21, it is assumed that the falling edge timing of the V-phase PWM signal matches the falling edge timing of the W-phase PWM signal in a state where the duty ratio of the U-phase PWM signal is close to 100% and the duty ratios of the V-phase PWM signal and the W-phase PWM signal are close to 0%. Even in this case, in order to avoid simultaneous switching of a plurality of phases based on the comparison technique, PWM signals cannot be generated by the normal method of generating the PWM signals by comparing the triangular wave TW with the three-phase duty command values, and the program becomes complicated.

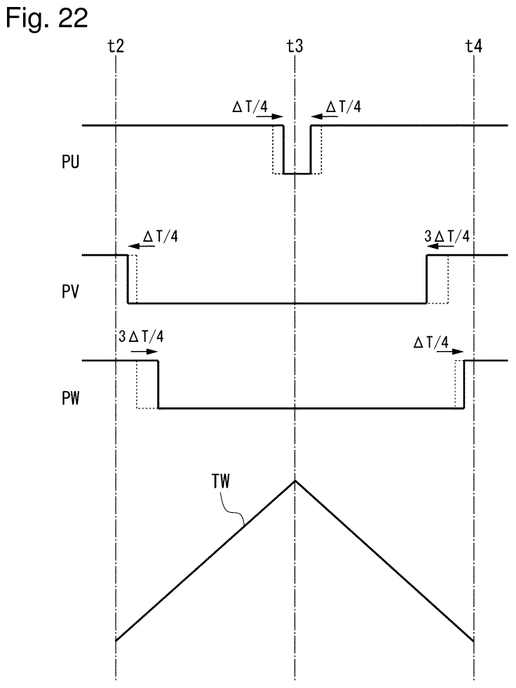

FIG. 22 is a timing chart illustrating an example of three-phase PWM signals generated by the present embodiment when a falling edge timing of the V-phase PWM signal matches a falling edge timing of the W-phase PWM signal in a state where the duty ratio of the U-phase PWM signal is close to 100% and the duty ratios of the V-phase PWM signal and the W-phase PWM signal are close to 0%.

In the present embodiment, when the type of the voltage fluctuations of the connection terminals of the first phase and the second phase predicted to match each other is a falling edge timing, the duty ratios of the voltage fluctuations of the connection terminals of the first phase and the second phase are included in a range from the second threshold to 0%, and the duty ratio of the voltage fluctuation of at least one of the remaining connection terminals is included in a range from the first threshold to 100%, the MCU 12 shifts the falling edge timing of the voltage fluctuation of the connection terminal of the first phase determined by the current update value in the delay direction by the first time, shifts the falling edge timing of the voltage fluctuation of the connection terminal of the second phase determined by the current update value in the advance direction by the fourth time, and shifts the falling edge timing of the voltage fluctuation of the remaining connection terminal determined by the current update value in the delay direction by the third time.

Further, the MCU 12 shifts the rising edge timing of the voltage fluctuation of the connection terminal of the second phase determined by the next update value or the previous update value of the three-phase duty command value in the advance direction by the second time, shifts the rising edge timing of the voltage fluctuation of the connection terminal of the first phase determined by the next update value or the previous update value in the delay direction by the fifth time, and shifts the rising edge timing of the voltage fluctuation of the remaining connection terminal determined by the next update value or the previous update value in the advance direction by the sixth time.

Specifically, as illustrated in FIG. 22, in the count-up period from time t2 to time t3, for example, the MCU 12 shifts the falling edge timing of the W-phase PWM signal PW in the delay direction by the first time (3ΔT/4), shifts the falling edge timing of the V-phase PWM signal PV in the advance direction by the fourth time (ΔT/4), and shifts the falling edge timing of the U-phase PWM signal PU in the delay direction by the third time (ΔT/4). Further, in the countdown period from time t3 to time t4, the MCU 12 shifts the rising edge timing of the V-phase PWM signal PV in the advance direction by the second time (3ΔT/4), shifts the rising edge timing of the W-phase PWM signal PW in the delay direction by the fifth time (ΔT/4), and shifts the rising edge timing of the U-phase PWM signal PU in the advance direction by the sixth time (ΔT/4).

As a result, even when the duty ratios of the two-phase PWM signals whose off-timings match each other are close to 0%, the timing of the PWM signals can be adjusted within the PWM cycle Tp. Therefore, PWM signals can be generated by a normal method of generating the PWM signals by comparing the triangular wave TW with the three-phase duty command values while avoiding simultaneous switching of a plurality of phases, and the shift amount of the edges close to the peak and the valley of the triangular wave TW can be suppressed. In the example of FIG. 22, the on-time of all the phases is uniformly extended by ΔT/2. The V-phase process and the W-phase process described above may be interchanged.

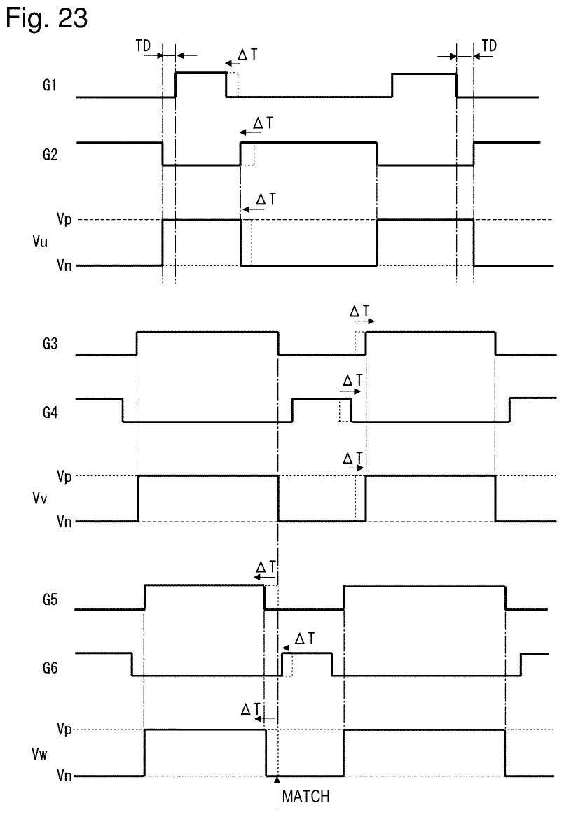

In the above description, the three-phase PWM signals in which the dead time is not considered are used, but the dead time is provided to the gate control signal supplied to each arm switch of the power conversion circuit 11. FIG. 23 is a timing chart illustrating an example of waveforms of the U-phase upper gate control signal G1, the U-phase lower gate control signal G2, the U-phase terminal voltage Vu, the V-phase upper gate control signal G3, the V-phase lower gate control signal G4, the V-phase terminal voltage Vv, the W-phase upper gate control signal G5, the W-phase lower gate control signal G6, and the W-phase terminal voltage Vw, in the case where both directions of the V-phase and W-phase currents are directions from the power conversion circuit 11 toward the three-phase motor 20. In FIG. 23, the U-phase terminal voltage Vu is a voltage of the U-phase connection terminal 13u, the V-phase terminal voltage Vv is a voltage of the V-phase connection terminal 13v, and the W-phase terminal voltage Vw is a voltage of the W-phase connection terminal 13w. Further, in FIG. 23, Vp represents the positive electrode potential of the DC power supply 30, and Vn represents the negative electrode potential of the DC power supply 30. For simplicity of explanation, the voltage drop when conducting the IGBT and the diode is ignored in FIG. 23.

As illustrated in FIG. 23, a dead time TD is inserted between the U-phase upper gate control signal G1 and the U-phase lower gate control signal G2. Although not illustrated, similarly, the dead time TD is inserted between the V-phase upper gate control signal G3 and the V-phase lower gate control signal G4 and between the W-phase upper gate control signal G5 and the W-phase lower gate control signal G6. When both directions of the currents of the V phase and the W phase are directions from the power conversion circuit 11 toward the three-phase motor 20, the V-phase terminal voltage Vv fluctuates in synchronization with the V-phase upper gate control signal G3, and the W-phase terminal voltage Vw fluctuates in synchronization with the W-phase upper gate control signal G5.

As illustrated in FIG. 23, for example, it is assumed that the V-phase upper gate control signal G3 and the W-phase upper gate control signal G5 coincide with each other at the off timing. In this case, since the V-phase terminal voltage Vv and the W-phase terminal voltage Vw simultaneously fluctuate from the positive electrode potential Vp to the negative electrode potential Vn of the DC power supply 30, the potential fluctuation of the neutral point N of the three-phase motor 20 becomes larger as compared with the case where only one phase fluctuates, and accordingly, the axial voltage of the three-phase motor 20 also greatly fluctuates to cause noise. In order to avoid this, in the present embodiment, when the off-timings of the V-phase upper gate control signal G3 and the W-phase upper gate control signal G5 are closer than the predetermined time ΔT, that is, when there is a possibility that the phase voltage fluctuation timings match each other due to a delay of the gate driver or the like, the off-timing of the W-phase upper gate control signal G5 determined by the current updated value of the W-phase duty command value DW is shifted in the advance direction by the first time ΔT, and the off-timing of the U-phase upper gate control signal G1 determined by the current updated value of the U-phase duty command value DU is shifted in the advance direction by the third time ΔT. Accordingly, regarding the W-phase lower gate control signal G6, the on-timing corresponding to the W-phase upper gate control signal G5 is shifted in the advance direction by the first time ΔT so as to maintain the dead time TD, and regarding the U-phase lower gate control signal G2, the on-timing corresponding to the U-phase upper gate control signal G1 is shifted in the advance direction by the third time ΔT so as to maintain the dead time TD. As a result, the waveform of the W-phase terminal voltage Vw is shifted in the advance direction by the first time ΔT, and the waveform of the U-phase terminal voltage Vu is also shifted in the advance direction by the third time ΔT.

In the present embodiment, the on-timing of the V-phase upper gate control signal G3 determined by the next update value of the V-phase duty command value DV is shifted in the delay direction by the second time ΔT. Accordingly, also in the V-phase lower gate control signal G4, the off-timing corresponding to the V-phase upper gate control signal G3 is shifted in the delay direction by the second time ΔT2 so as to maintain the dead time TD. As a result, the waveform of the V-phase terminal voltage Vv is also shifted in the delay direction by the second time ΔT2. With the above operation, it is possible to prevent the two phase voltages from simultaneously fluctuating in the same direction, and as a result, it is possible to suppress the axial voltage of the three-phase motor 20 from greatly fluctuating instantaneously.

As described above, when both directions of the currents of the V phase and the W phase are directions from the power conversion circuit 11 toward the three-phase motor 20, the V-phase terminal voltage Vv fluctuates in synchronization with the V-phase upper gate control signal G3, and the W-phase terminal voltage Vw fluctuates in synchronization with the W-phase upper gate control signal G5. On the other hand, although not illustrated, when both directions of the currents of the V phase and the W phase are directions from the three-phase motor 20 toward the power conversion circuit 11, the V-phase terminal voltage Vv fluctuates in synchronization with the V-phase lower gate control signal G4, and the W-phase terminal voltage Vw fluctuates in synchronization with the W-phase lower gate control signal G6. In the present embodiment, in consideration of this point, it is determined whether or not voltage fluctuations of at least two-phase connection terminals among the three-phase connection terminals 13u, 13v, and 13w have occurred in the same direction and at the same timing.

Since the lower gate control signal is merely a signal shifted from the upper gate control signal by the dead time TD, in determining whether or not the switch timing matches, it is not necessary to consider the influence of the dead time TD when the direction of the current is the same. When the timing of the upper gate control signal matches, the timing of the lower gate control signal shifted from the upper gate control signal by the dead time TD also matches.

In the above example, the U-phase gate control signal and the W-phase gate control signal are advanced at the match occurrence timing, but the V-phase gate control signal may be advanced instead of the W-phase gate control signal, and in this case, the next W-phase gate control signal is shifted in the delay direction. In addition, at the matching occurrence timing, the U-phase gate control signal and the W-phase gate control signal may be shifted in the delay direction instead of being advanced, and in that case, the next V-phase gate control signal is shifted in the advance direction.

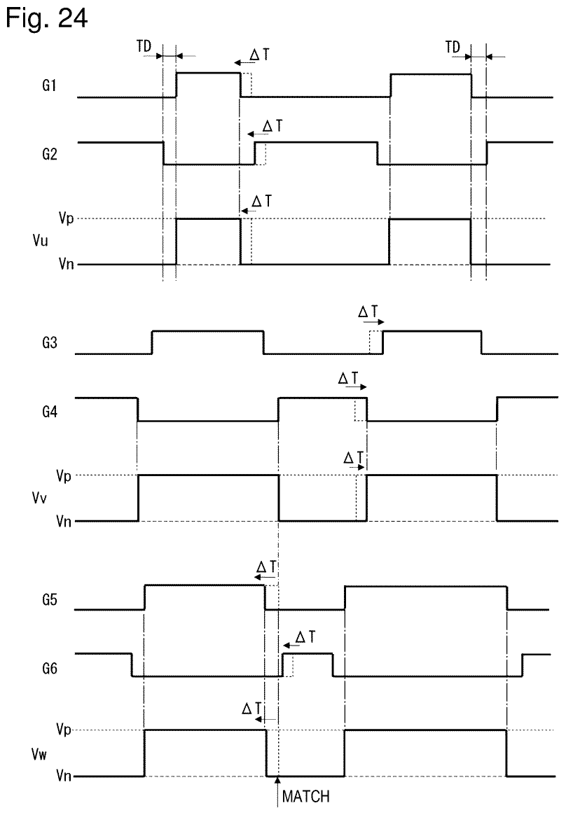

FIG. 24 is a timing chart illustrating an example of waveforms of the U-phase upper gate control signal G1, the U-phase lower gate control signal G2, the U-phase terminal voltage Vu, the V-phase upper gate control signal G3, the V-phase lower gate control signal G4, the V-phase terminal voltage Vv, the W-phase upper gate control signal G5, the W-phase lower gate control signal G6, and the W-phase terminal voltage Vw, in the case where the direction of the V-phase current is a direction from the three-phase motor 20 toward the power conversion circuit 11 and the direction of the W-phase current is a direction from the three-phase motor 20 toward the power conversion circuit 11.

As illustrated in FIG. 24, when the direction of the V-phase current is a direction from the three-phase motor 20 toward the power conversion circuit 11 and the direction of the W-phase current is a direction from the three-phase motor 20 toward the power conversion circuit 11, the V-phase terminal voltage Vv fluctuates in synchronization with the V-phase lower gate control signal G4, and the W-phase terminal voltage Vw fluctuates in synchronization with the W-phase upper gate control signal G5.

As illustrated in FIG. 24, for example, it is assumed that the on-timing of the V-phase lower gate control signal G4 matches the off-timing of the W-phase upper gate control signal G5. In this case, since the V-phase terminal voltage Vv and the W-phase terminal voltage Vw simultaneously fluctuate from the positive electrode potential Vp to the negative electrode potential Vn of the DC power supply 30, the axial voltage of the three-phase motor 20 also greatly fluctuates, which causes noise. In order to avoid this, in the present embodiment, when the on-timing of the V-phase lower gate control signal G4 and the off-timing of the W-phase upper gate control signal G5 are closer than the predetermined time ΔT, the off-timing of the W-phase upper gate control signal G5 determined by the current updated value of the W-phase duty command value DW is shifted in the advance direction by the first time ΔT, and the off-timing of the U-phase upper gate control signal G1 determined by the current updated value of the U-phase duty command value DU is shifted in the advance direction by the third time ΔT. Accordingly, regarding the W-phase lower gate control signal G6, the on-timing corresponding to the W-phase upper gate control signal G5 is shifted in the advance direction by the first time ΔT so as to maintain the dead time TD, and regarding the U-phase lower gate control signal G2, the on-timing corresponding to the U-phase upper gate control signal G1 is shifted in the advance direction by the third time ΔT so as to maintain the dead time TD. As a result, the waveform of the W-phase terminal voltage Vw is shifted in the advance direction by the first time ΔT, and the waveform of the U-phase terminal voltage Vu is also shifted in the advance direction by the third time ΔT.

In the present embodiment, the on-timing of the V-phase upper gate control signal G3 determined by the next update value of the V-phase duty command value DV is shifted in the delay direction by the second time ΔT. Accordingly, also in the V-phase lower gate control signal G4, the off-timing corresponding to the V-phase upper gate control signal G3 is shifted in the delay direction by the second time ΔT2 so as to maintain the dead time TD. As a result, the waveform of the V-phase terminal voltage Vv is also shifted in the delay direction by the second time ΔT2. With the above operation, it is possible to prevent the two phase voltages from simultaneously fluctuating in the same direction, and as a result, it is possible to suppress the axial voltage of the three-phase motor 20 from greatly fluctuating instantaneously.

As described above, when the direction of the V-phase current is a direction from the three-phase motor 20 toward the power conversion circuit 11 and the direction of the W-phase current is a direction from the three-phase motor 20 toward the power conversion circuit 11, the V-phase terminal voltage Vv fluctuates in synchronization with the V-phase lower gate control signal G4, and the W-phase terminal voltage Vw fluctuates in synchronization with the W-phase upper gate control signal G5. Therefore, in the determination on whether or not matching of the switch timing occurs, the timing shifted by the dead time TD with respect to the upper gate control signal for the phase of the negative current (in this case, the V-phase) may be regarded as the “voltage fluctuation timing of the connection terminal”.

In the phase of the positive current (in this case, the W-phase), the connection terminal voltage fluctuates in synchronization with the upper gate control signal. On the other hand, in the phase of the negative current, the connection terminal voltage increases at a timing earlier than the turn-on timing of the upper gate control signal by the dead time TD, and the connection terminal voltage decreases at a timing later than the turn-off timing of the upper gate control signal by the dead time TD. It is necessary to consider this in the determination of whether or not the switching timings match.

In the above example, the U-phase gate control signal and the W-phase gate control signal are advanced at the match occurrence timing, but the V-phase gate control signal may be advanced instead of the W-phase gate control signal, and in this case, the next W-phase gate control signal is shifted in the delay direction. In addition, at the matching occurrence timing, the U-phase gate control signal and the W-phase gate control signal may be shifted in the delay direction instead of being advanced, and in that case, the next V-phase gate control signal is shifted in the advance direction.

As described above, in the present embodiment, in the case of providing the dead time, it is determined whether the voltage fluctuation of at least two phase connection terminals among the three-phase connection terminals 13u, 13v, and 13w has occurred in the same direction and at the same timing, in consideration of (1) whether the terminal voltage fluctuation is synchronized with the upper gate control signal or the lower gate control signal varies depending on the direction of the current, and (2) whether the turn-on timing is delayed by the dead time due to the provided dead time, for example.

As described above, according to one embodiment of the present disclosure, it is avoided that voltage fluctuations of the connection terminals of at least two phases, among the three-phase connection terminals 13u, 13v, and 13w, occur in the same direction and at the same timing, and thus, it is possible to suppress instantaneous large fluctuation of the axial voltage of the three-phase motor 20. That is, according to one embodiment of the present disclosure, it is possible to reduce the noise caused by instantaneous large fluctuation of the axial voltage. As a result, according to one embodiment of the present disclosure, it is possible to suppress occurrence of electrolytic corrosion in the rotor bearing of the three-phase motor 20.

The present invention is not limited to the above embodiment, and the configurations described in the present description can be appropriately combined within a range not conflicting with one another.

For example, in the above embodiment, the motor control device 10 that controls the three-phase motor 20 has been exemplified, but the motor to be controlled is not limited to the three-phase motor 20, and may be an n-phase motor (n is an integer of 3 or more).

In the above embodiment, the IGBT is exemplified as each arm switch included in the power conversion circuit 11, but each arm switch may be, for example, a high-power switching element other than the IGBT such as a MOS-FET.

Features of the above-described preferred embodiments and the modifications thereof may be combined appropriately as long as no conflict arises.

While preferred embodiments of the present disclosure have been described above, it is to be understood that variations and modifications will be apparent to those skilled in the art without departing from the scope and spirit of the present disclosure. The scope of the present disclosure, therefore, is to be determined solely by the following claims.

1. A motor control device that controls an n-phase motor (n is an integer of 3 or more), the motor control device comprising:
a power conversion circuit that is connected to the n-phase motor and performs mutual conversion between DC power and n-phase AC power; and
a control unit that controls the power conversion circuit based on n-phase duty command values updated at a predetermined update cycle, wherein
when the control unit predicts, based on each of current update values of the n-phase duty command values, that voltage fluctuations of connection terminals of at least a first phase and a second phase among n-phase connection terminals connected to the n-phase motor occur in a same direction and at a same timing, the control unit shifts an occurrence timing of the voltage fluctuation of the connection terminal of the first phase determined by the current update value in a first direction by a first time, shifts an occurrence timing of a voltage fluctuation of a remaining connection terminal determined by the current update value in the first direction by a third time, and shifts an occurrence timing of the voltage fluctuation of the connection terminal of the second phase determined by a next update value or a previous update value of the n-phase duty command value in a direction opposite to the first direction by a second time.

2. The motor control device according to claim 1, wherein
the control unit determines the first direction as one of a delay direction and an advance direction on a basis of a type of occurrence timings of the voltage fluctuations of the connection terminals of the first phase and the second phase predicted to match each other and duty ratios of the voltage fluctuations of the connection terminals of at least the first phase and the second phase, and
the type of the occurrence timing includes a rising edge timing and a falling edge timing.

3. The motor control device according to claim 2, wherein when the type of the occurrence timings of the voltage fluctuations of the connection terminals of the first phase and the second phase predicted to match each other is the rising edge timing, and the duty ratios of the voltage fluctuations of the connection terminals of the first phase and the second phase are included in a range from a first threshold to 100%, the control unit shifts the rising edge timing of the voltage fluctuation of the remaining connection terminal determined by the current update value in the delay direction by the third time, shifts the rising edge timing of the voltage fluctuation of the connection terminal of the first phase determined by the current update value in the delay direction by the first time, and shifts the falling edge timing of the voltage fluctuation of the connection terminal of the second phase determined by the next update value or the previous update value of the n-phase duty command value in the advance direction by the second time.

4. The motor control device according to claim 2, wherein when the type of the occurrence timings of the voltage fluctuations of the connection terminals of the first phase and the second phase predicted to match each other is the rising edge timing, and the duty ratios of the voltage fluctuations of the connection terminals of the first phase and the second phase are included in a range from a second threshold to 0%, the control unit shifts the rising edge timing of the voltage fluctuation of the remaining connection terminal determined by the current update value in the advance direction by the third time, shifts the rising edge timing of the voltage fluctuation of the connection terminal of the first phase determined by the current update value in the advance direction by the first time, and shifts the falling edge timing of the voltage fluctuation of the connection terminal of the second phase determined by the next update value or the previous update value of the n-phase duty command value in the delay direction by the second time.

5. The motor control device according to claim 2, wherein when the type of the occurrence timings of the voltage fluctuations of the connection terminals of the first phase and the second phase predicted to match each other is the falling edge timing, and the duty ratios of the voltage fluctuations of the connection terminals of the first phase and the second phase are included in a range from a first threshold to 100%, the control unit shifts the falling edge timing of the voltage fluctuation of the remaining connection terminal determined by the current update value in the advance direction by the third time, shifts the falling edge timing of the voltage fluctuation of the connection terminal of the first phase determined by the current update value in the advance direction by the first time, and shifts the rising edge timing of the voltage fluctuation of the connection terminal of the second phase determined by the next update value or the previous update value of the n-phase duty command value in the delay direction by the second time.

6. The motor control device according to claim 2, wherein when the type of the occurrence timings of the voltage fluctuations of the connection terminals of the first phase and the second phase predicted to match each other is the falling edge timing, and the duty ratios of the voltage fluctuations of the connection terminals of the first phase and the second phase are included in a range from a second threshold to 0%, the control unit shifts the falling edge timing of the voltage fluctuation of the remaining connection terminal determined by the current update value in the delay direction by the third time, shifts the falling edge timing of the voltage fluctuation of the connection terminal of the first phase determined by the current update value in the delay direction by the first time, and shifts the rising edge timing of the voltage fluctuation of the connection terminal of the second phase determined by the next update value or the previous update value of the n-phase duty command value in the advance direction by the second time.

7. The motor control device according to claim 2, wherein
when the type of the voltage fluctuations of the connection terminals of the first phase and the second phase predicted to match each other is the rising edge timing, the duty ratios of the voltage fluctuations of the connection terminals of the first phase and the second phase are included in a range from a first threshold to 100%, and the duty ratio of the voltage fluctuation of at least one of the remaining connection terminals is included in a range from a second threshold to 0%, the control unit shifts the rising edge timing of the voltage fluctuation of the connection terminal of the first phase determined by the current update value in the delay direction by the first time, shifts the rising edge timing of the voltage fluctuation of the connection terminal of the second phase determined by the current update value in the advance direction by a fourth time, and shifts the rising edge timing of the voltage fluctuation of the remaining connection terminal determined by the current update value in the delay direction by the third time, and,
shifts the falling edge timing of the voltage fluctuation of the connection terminal of the second phase determined by the next update value or the previous update value of the n-phase duty command value in the advance direction by the second time, shifts the falling edge timing of the voltage fluctuation of the connection terminal of the first phase determined by the next update value or the previous update value in the delay direction by a fifth time, and shifts the falling edge timing of the voltage fluctuation of the remaining connection terminal determined by the next update value or the previous update value in the advance direction by a sixth time.

8. The motor control device according to claim 2, wherein
when the type of the voltage fluctuations of the connection terminals of the first phase and the second phase predicted to match each other is the falling edge timing, the duty ratios of the voltage fluctuations of the connection terminals of the first phase and the second phase are included in a range from a first threshold to 100%, and the duty ratio of the voltage fluctuation of at least one of the remaining connection terminals is included in a range from a second threshold to 0%, the control unit shifts the falling edge timing of the voltage fluctuation of the connection terminal of the first phase determined by the current update value in the advance direction by the first time, shifts the rising edge timing of the voltage fluctuation of the connection terminal of the second phase determined by the current update value in the delay direction by a fourth time, and
shifts the falling edge timing of the voltage fluctuation of the remaining connection terminal determined by the current update value in the advance direction by the third time, and, shifts the rising edge timing of the voltage fluctuation of the connection terminal of the second phase determined by the next update value or the previous update value of the n-phase duty command value in the delay direction by the second time, shifts the rising edge timing of the voltage fluctuation of the connection terminal of the first phase determined by the next update value or the previous update value in the advance direction by a fifth time, and shifts the rising edge timing of the voltage fluctuation of the remaining connection terminal determined by the next update value or the previous update value in the delay direction by a sixth time.

9. The motor control device according to claim 2, wherein
when the type of the voltage fluctuations of the connection terminals of the first phase and the second phase predicted to match each other is the rising edge timing, the duty ratios of the voltage fluctuations of the connection terminals of the first phase and the second phase are included in a range from a second threshold to 0%, and the duty ratio of the voltage fluctuation of at least one of the remaining connection terminals is included in a range from a first threshold to 100%, the control unit shifts the rising edge timing of the voltage fluctuation of the connection terminal of the first phase determined by the current update value in the advance direction by the first time, shifts the rising edge timing of the voltage fluctuation of the connection terminal of the second phase determined by the current update value in the delay direction by a fourth time, and shifts the rising edge timing of the voltage fluctuation of the remaining connection terminal determined by the current update value in the advance direction by the third time, and,
shifts the falling edge timing of the voltage fluctuation of the connection terminal of the second phase determined by the next update value or the previous update value of the n-phase duty command value in the delay direction by the second time, shifts the falling edge timing of the voltage fluctuation of the connection terminal of the first phase determined by the next update value or the previous update value in the advance direction by a fifth time, and shifts the falling edge timing of the voltage fluctuation of the remaining connection terminal determined by the next update value or the previous update value in the delay direction by a sixth time.

10. The motor control device according to claim 2, wherein
when the type of the voltage fluctuations of the connection terminals of the first phase and the second phase predicted to match each other is the falling edge timing, the duty ratios of the voltage fluctuations of the connection terminals of the first phase and the second phase are included in a range from a second threshold to 0%, and the duty ratio of the voltage fluctuation of at least one of the remaining connection terminals is included in a range from a first threshold to 100%, the control unit shifts the falling edge timing of the voltage fluctuation of the connection terminal of the first phase determined by the current update value in the delay direction by the first time, shifts the falling edge timing of the voltage fluctuation of the connection terminal of the second phase determined by the current update value in the advance direction by a fourth time, and shifts the falling edge timing of the voltage fluctuation of the remaining connection terminal determined by the current update value in the delay direction by the third time, and,
shifts the rising edge timing of the voltage fluctuation of the connection terminal of the second phase determined by the next update value or the previous update value of the n-phase duty command value in the advance direction by the second time, shifts the rising edge timing of the voltage fluctuation of the connection terminal of the first phase determined by the next update value or the previous update value in the delay direction by a fifth time, and shifts the rising edge timing of the voltage fluctuation of the remaining connection terminal determined by the next update value or the previous update value in the advance direction by a sixth time.
